(19) United States
(12) Patent Application Publication
(10) Pub. No.: US 2023/0090228 A1
(43) Pub. Date: Mar. 23, 2023

(54) WIRELESS COMMUNICATION DEVICE

(71) Applicant: KABUSHIKI KAISHA TOSHIBA, Tokyo (JP)

(72) Inventors: Masahiro SEKIYA, Inagi Tokyo (JP); Tomoko ADACHI, Kawasaki Kanagawa (JP)

(73) Assignee: KABUSHIKI KAISHA TOSHIBA, Tokyo (JP)

(21) Appl. No.: 17/686,742

(22) Filed: Mar. 4, 2022

(30) Foreign Application Priority Data
Sep. 17, 2021 (JP) 2021-151744

(51) Int. Cl. H04W 72/12; H04L 5/00

(52) U.S. Cl. CPC H04W 72/1284; H04L 5/0032

(57) ABSTRACT

According to one embodiment, a wireless communication device includes a control unit and a wireless unit. The control unit is configured to confirm whether or not a notification that a first frame was successfully transmitted is received from a second communication device. The control unit is configured to transmit, in a case where the notification is not received, the first frame to a first communication device via the wireless unit, and transmit, in a case where a response frame with respect to the first frame is successfully received from the first communication device, the notification to the second communication device. The control unit is configured to discard, in a case where the notification is received, the first frame.

### CROSS-REFERENCE TO RELATED APPLICATIONS

This application is based upon and claims the benefit of priority from Japanese Patent Application No. 2021-151744, filed Sep. 17, 2021, the entire contents of which are incorporated herein by reference.

### FIELD

Embodiments described herein relate generally to a wireless communication device.

### BACKGROUND

In recent years, various kinds of technologies have been proposed to improve the reliability of communication. One of them is the multi-link transmission technology. In multi-link transmission, a multi-link device in which multiple wireless functions are implemented in one housing is linked and coordinated, and multiple wireless links are established between a wireless base station multi-link device comprising multiple wireless functions operating as an access point and a wireless terminal multi-link device comprising multiple wireless functions operating as a station. Such multiple wireless links are used to transmit data. According to this multi-link transmission technology, it is possible to transmit the same data in parallel using multiple wireless links, thus improving the reliability of communication.

However, in the multi-link transmission technology, in some cases, data that has already been transmitted using one of the multiple wireless links and for which a transmission confirmation of successful transmission is already obtainable may be transmitted separately using another wireless link, resulting in inefficient communication.

### BRIEF DESCRIPTION OF THE DRAWINGS

FIG. 1 shows a schematic configuration example of a wireless communication system including a wireless communication device according to an embodiment.

FIG. 2 shows a frame format of a MAC frame.

FIG. 3 shows a schematic configuration example of the wireless communication device according to the embodiment.

FIG. 4 is a flowchart showing a processing procedure executed by a wireless base station to establish a wireless connection with a wireless terminal in a multi-link mode.

FIG. 5 is a block diagram showing a schematic configuration example of the wireless communication system according to the embodiment.

FIG. 6 shows a frame format of a beacon frame.

FIG. 7 shows a field configuration example of a Multi-Link element.

FIG. 8 shows an example of a setting value set for each field configuring the Multi-Link element.

FIG. 9 shows a field configuration example of a Reduced Neighbor Report element.

FIG. 10 shows an example of a setting value set for each field configuring the Reduced Neighbor Report element.

FIG. 11 shows an example of a setting value set for each field configuring a Multi-Link element included in an association request frame.

FIG. 12 is a flowchart showing a processing procedure up to where a multi-AP controller transfers transmission data addressed to a first wireless terminal to a first wireless base station and a second wireless base station.

FIG. 13 shows setting examples of a TID, a sequence number, and a management number included in a transfer frame.

FIG. 14 shows a frame format of an Ethernet frame.

FIG. 15 is a flowchart showing a processing procedure by which the first wireless base station transmits transmission data to the first wireless terminal.

FIG. 16 shows an example of a setting value set for each field configuring a Multi-Link element.

FIG. 17 shows an example of a setting value set for each field configuring a Reduced Neighbor Report element.

FIG. 18 shows a frame format of an A-MPDU frame.

FIG. 19 shows a frame format of a BA frame.

FIG. 20 shows a frame format of a BAR frame.

FIG. 21 as a diagram for explaining a control method of a Block Ack Window.

FIG. 22 is a flowchart showing a processing procedure for updating a reception history of a wireless terminal.

FIG. 23 is a block diagram showing a schematic configuration example of the wireless communication system according to the embodiment.

FIG. 24 is a block diagram showing a schematic configuration example of the wireless terminal according to the embodiment.

FIG. 25 is a diagram for explaining controls performed by SCC and RxRBC.

FIG. 26 is a flowchart showing a processing procedure for updating a BA Window.

FIG. 27 is a flowchart showing another processing procedure for updating the BA Window.

FIG. 28 shows a frame format of an Action frame.

FIG. 29 shows a frame format of a DELBA frame.

FIG. 30 shows a frame format of an ADDBA Request frame.

FIG. 31 shows a frame format of a BAR frame.

### DETAILED DESCRIPTION

In general, according to one embodiment, a wireless communication device includes a control unit and a wireless unit. The control unit is configured to generate a first frame based on data and management information corresponding to the data. The wireless unit is configured to transmit the first frame to a first communication device. The control unit is configured to confirm whether or not a notification including the management information that the first frame was successfully transmitted is received from a second communication device which is different from the first communication device. The control unit is configured to transmit, in a case where the notification is not received, the first frame to the first communication device via the wireless unit, and transmit, in a case where a response frame with respect to the first frame is successfully received from the first communication device, the notification including the management information to the second communication device. The control unit is configured to discard, in a case where the notification is received, the first frame.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

### First Embodiment

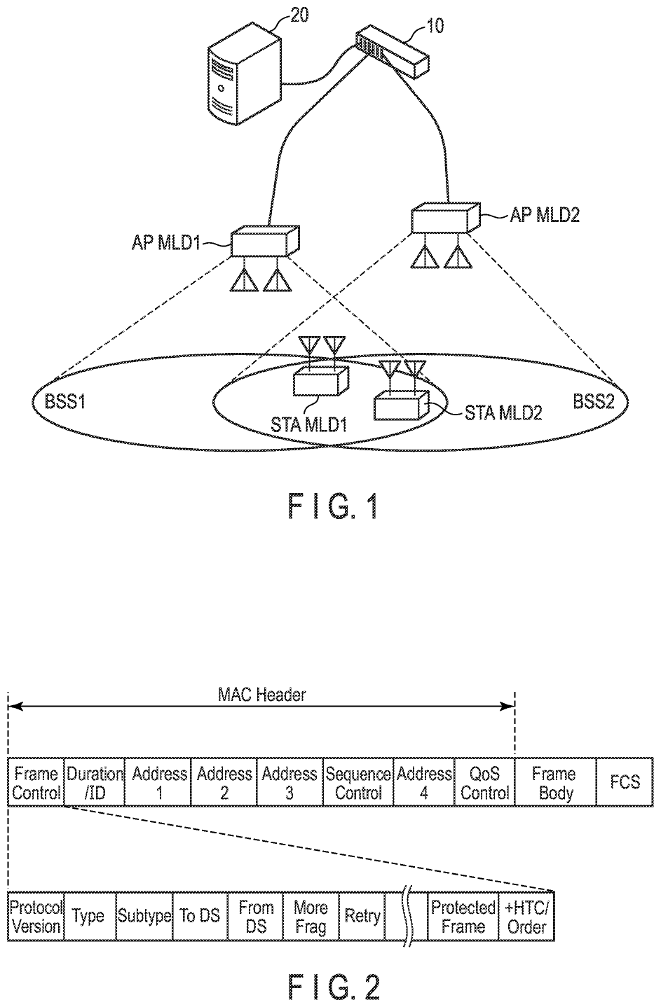

FIG. 1 shows a schematic configuration example of a wireless communication system including a wireless communication device according to a first embodiment. The wireless communication system shown in FIG. 1 comprises a first wireless base station AP MLD1 and a second wireless base station AP MLD2 operating as an access point multi-link device (AP MLD), a first wireless terminal STA MLD1 and a second wireless terminal STA MLD2 operating as a non-access point multi-link device (non-AP MLD), and a control device 20 wired to the first wireless base station AP MLD1 and the second wireless base station AP MLD2 via a hub 10. As will be described in detail later, the first wireless base station AP MLD1, the second wireless base station AP MLD2, the first wireless terminal STA MLD1, and the second wireless terminal STA MLD2 can all be realized by the same configuration, and may all be referred to as wireless communication devices. In the present specification, in a case where it is unnecessary to distinguish between the first wireless base station AP MLD1 and the second wireless base station AP MLD2, the base stations may be simply referred to as the wireless base station AP MLD. Similarly, in a case where it is unnecessary to distinguish between the first wireless terminal STA MLD1 and the second wireless terminal STA MLD2, the terminals may be simply referred to as the wireless terminal STA MLD.

The first wireless base station AP MLD1 is capable of communicating with both the first wireless terminal STA MLD1 and the second wireless terminal STA MLD2. The second wireless base station AP MLD2 is also capable of communicating with both the first wireless terminal STA MLD1 and the second wireless terminal STA MLD2. In other words, both the first wireless terminal STA MLD1 and the second wireless terminal STA MLD2 belong to the networks of both the first wireless base station AP MLD1 and the second wireless base station AP MLD2, and can communicate with the first wireless base station AP MLD1 and the second wireless base station AP MLD2 by a wireless LAN (Local Area Network) method.

FIG. 1 is assumed to be a case in which an infrastructure mode network is configured, where the first wireless terminal STA MLD1 and the second wireless terminal STA MLD2 perform wireless communication via the first wireless base station AP MLD1 or the second wireless base station AP MLD2. In the infrastructure mode network, a range in which wireless signals of the wireless base stations reach the wireless terminals is referred to as a basic service set (BSS). In FIG. 1, a range in which wireless signals of the first wireless base station AP MLD1 reach the wireless terminals is denoted as BSS1, and a range in which wireless signals of the second wireless base station AP MLD2 reach the wireless terminals is denoted as BSS2.

The wireless base stations included in the wireless communication system do not necessarily have to be fixed to a certain point. For example, a wireless terminal that functions as a simple wireless base station by changing its operation mode may operate as a wireless base station included in the wireless communication system. Here, a case of configuring an infrastructure mode network in which a plurality of wireless terminals included in the wireless communication system perform wireless communication via the wireless base station is assumed. However, the wireless communication system is not limited thereto, and may also configure an ad hoc mode network in which a plurality of wireless terminals perform wireless communication without a wireless base station. In this case, any one of the wireless terminals may operate as the owner in the ad hoc mode network. As described above, a wireless terminal can also be a wireless base station, and since a wireless base station and a wireless terminal can be realized by the same configuration, both a wireless base station and a wireless terminal can be referred to as a wireless communication device as mentioned above.

In FIG. 1, the first wireless base station AP MLD1 and the second wireless base station AP MLD2 are connected to the control device 20 by a wired connection (e.g., Ethernet (registered trademark)) via the hub 10. The control device 20 transfers frames to be sent so the wireless terminals to the first and second wireless base stations AP MLD1 and AP MLD2.

In the following, a frame format used in the wireless communication system shown in FIG. 1 will first be explained.

FIG. 2 shows a frame format of a media access control (MAC) frame. FIG. 2 shows the frame format of the MAC frame used by a wireless communication system of the IEEE 802.11 standard (including IEEE 802.11a, IEEE 802.11b, IEEE 802.11g, IEEE 802.11n, IEEE 802.11ac, IEEE 802.11ax, IEEE 802.11be, and 802.11 standards to be defined in the future).

As shown in FIG. 2, the MAC frame is configured by a MAC Header, a Frame Body field, and a Frame Check Sequence (FCS) field. The MAC Header is set with information necessary for reception processing in a MAC layer. The Frame Body field is set with information according to the type of frame (e.g., data from an upper layer, etc.). The FCS field is set with an error detection code (CRC: cyclic redundancy code) calculated to determine whether or not the MAC Header and the Frame Body field were successfully received.

As shown in FIG. 2, the MAC Header includes a Frame Control field, a Duration/ID field, an Address 1 field, an Address 2 field, an Address 3 field, a Sequence Control field, an Address 4 field, and a Quality of Service (QoS) Control field. The various fields included in the MAC Header are not limited to the fields described above; for example, new fields may further be added, or some fields may be deleted.

The Frame Control field is set to a value in accordance with the type of frame.

More specifically, as shown in FIG. 2, the Frame Control field includes a Protocol Version field, a Type field, a Subtype field, a To DS field, a From DS field, a More Fragment field, a Retry field, a Protected Frame field, and a +HTC/Order field.

The Protocol Version field is set with information indicating a protocol version to be used.

The Type field contains a bit string indicating the type of the MAC frame. By referring to the Type field, it is possible to recognize whether the type (frame type) of the MAC frame is a control frame, a management frame, or a data frame.

The Subtype field contains a bit string indicating the type of the MAC frame within the frame type indicated by the Type field.

The To DS field is set with information relating to a receiving station, and indicates whether the receiving station is a wireless base station or a wireless terminal. Specifically, in the case where the bit is 1, it indicates that the receiving station is a wireless base station, and in the case where the bit is 0, it indicates that the receiving station is a wireless terminal.

The From DS field is set with information relating to a transmitting station, and indicates whether the transmitting station is a wireless base station or a wireless terminal. Specifically, in the case where the bit is 1, it indicates that the transmitting station is a wireless base station, and in the case where the bit is 0, it indicates that the transmitting station is a wireless terminal.

The More Fragment field is used in the case where upper layer data is fragmented, and is set with information indicating whether or not there is a subsequent fragment frame. Specifically, in the case where the bit is 1, it indicates that there is a subsequent fragment frame, and in the case where the bit is 0, it indicates that there is no subsequent fragment frame.

In the Retry field, information indicating whether or not the frame is a retransmitted frame (retransmission frame) is set. Specifically, in the case where the bit is 1, it indicates that the frame is a retransmission frame, and in the case where the bit is 0, it indicates that the frame is not a retransmission frame.

In the Protected Frame field, information indicating whether or not the frame is encrypted (protected) is set. Specifically, in the case where the bit is 1, it indicates that the frame is encrypted, and in the case where the bit is 0, it indicates that the frame is not encrypted.

The +HTC/Order field indicates that, in the case where a non-QoS data frame is transmitted, the order of the frames should not be switched when relaying the frames, and, in the case where a QoS data frame is transmitted in an IEEE 602.11n/ac/ax physical frame, the MAC Header includes an HT Control field (not shown). The HT Control field is included between the QoS Control field and the Frame Body field and is used to notify some of the functions specified in IEEE 802.11n/ac/ax.

Note that the various fields included in the Frame Control field are not limited to the fields described above. For example, new fields may further be added, and some fields may be deleted.

The Duration/ID field has a length of 16 bits. In the case where the most significant bit (MSB) is 0, the lower 15 bits indicate a transmission inhibition period (NAV: Network Allocation Vector), and in the case where the most significant bit is 1, a part of the lower 15 bits indicates an identification number assigned to a wireless terminal connected to a wireless base station.

The Address 1 field contains a MAC address of a direct receiving station, and is used, for example, when determining whether or not the frame is addressed to its own device.

The Address 2 field contains a MAC address of a direct transmitting station.

The Address 3 field contains a MAC address of a device that is to be the final destination in the uplink, and a MAC address of a device that is the transmission source in the downlink.

The Address 4 field is set only in a case where the wireless base station transmits a frame to another wireless base station, and contains a MAC address of a device that is the transmission source.

In the Sequence Control field, a sequence number of the frame to be transmitted and a fragmentation number in the case where data is fragmented are set.

The QoS Control field is a field added in a case where the frame type indicated by the Type field is a data frame, and the type of the MAC frame indicated by the Subtype field is a QoS data frame. The QoS Control field includes a TID (Traffic ID) field in which an identifier according to data traffic is set, and an Ack policy field in which a delivery confirmation method is set, etc. For example, the TID field is used when determining the traffic type of the data. The Ack policy field is used when determining which of the policies of NormalAckpolicy, BlockAckpolicy, or NoAckpolicy the transmission of the QoS data was based on.

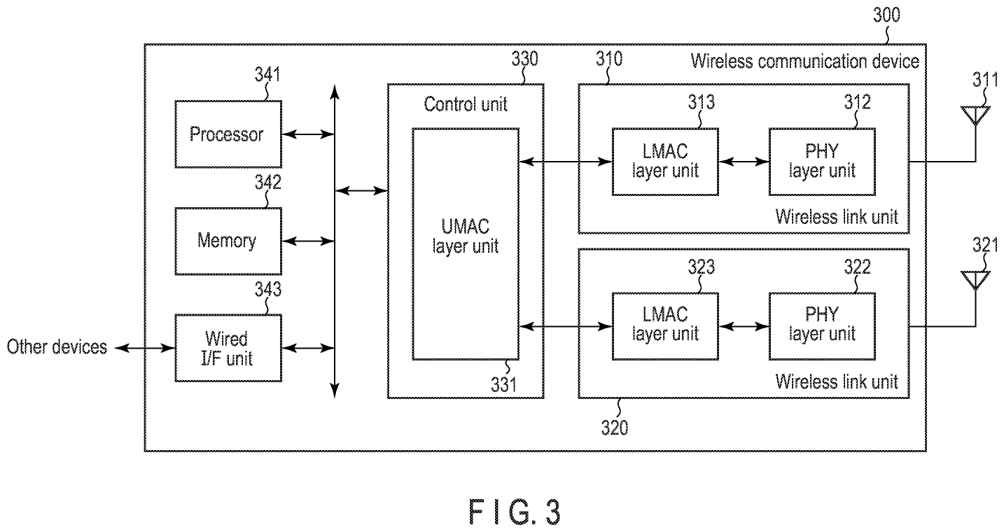

Now, with reference to FIG. 3, a schematic configuration example of the wireless communication device (wireless base station and wireless terminal) according to the present embodiment will be described. As described above, wireless communication device 300 is, for example, a device that complies with the IEEE 802.11 standard. The configuration of the wireless communication device 300 shown in FIG. 3 can be applied to both the wireless base station AP MLD and the wireless terminal STA MLD, as described above.

As shown in FIG. 3, the wireless communication device 300 comprises wireless link units 310 and 320, antennas 311 and 321, a control unit 230, a processor 341, a memory 342, and a wired I/F (interface) unit 343. Since the wireless link unit 310 and the antenna 311 and the wireless link unit 320 and the antenna 321 have similar functions, in the following, only the wireless link unit 310 and the antenna 311 will be described as representative examples.

The antenna 311 receives analog wireless signals transmitted in, for example, 2.4 GHz, 5 GHz, and 6 GHz bands. Received signals received by the antenna 311 are input to the wireless link unit 310. The wireless link unit 310 comprises a physical (PHY) layer unit 312 and a lower MAC (LMAC) layer unit 313.

Although detailed illustrations are omitted in FIG. 3, the PHY layer unit 312 includes an antenna switch, a wireless receiver, wireless transmitter, an oscillator, a demodulator, a modulator, and the like.

When a received signal from the antenna 311 is input to the wireless receiver included in the PHY layer unit 312, the received signal is frequency-converted (down-converted) to a signal of an appropriate frequency band (e.g., a baseband signal) using a signal of the same frequency as a carrier signal generated by the oscillator. The frequency-converted signal is then converted into a digital signal by an analog-to-digital converter (ADC) and input to the demodulator. The demodulator performs, for example, reception processing including a predetermined demodulation and decryption processing with respect to the input digital signal in accordance with the IEEE 802.11 standard (including IEEE 802.11a, IEEE 802.11b, IEEE 802.11g, IEEE 202.11n, IEEE 802.11ac, IEEE 802.11ax, IEEE 802.11be, and 802.11 standards to be defined in the future), converts the digital signal into a MAC frame specified in the IEEE 802.11 standard, and transfers the MAC frame to the LMAC layer unit 515.

In the demodulator, OFDM symbol timing synchronization, Fast Fourier Transform (FFT) processing, de-interleaving processing, error correction code processing, etc., are performed on the digital signal converted by the ADC. A PHY header in a PHY frame (PHY Protocol Data Unit (PPDU)) demodulated by the demodulator includes information indicating frame length, information indicating transmission rate, bandwidth information, etc. Such information is extracted by the demodulator. The demodulator uses the extracted information in demodulation processing or transfers it to the LMAC layer unit 313.

In the reception processing, the LMAC layer unit 313 performs de-aggregation processing, CRC check processing, MAC header analysis processing, etc. In the case of receiving an A-MPDU frame (described later), the de-aggregation processing decomposes the A-MPDU frame into one or more MAC frames (MAC Protocol Data Units (MPDUs)). The CRC check processing confirms that a CRC added to each MPDU is correct. As a result, if the CRC is not correct, the MPDU to which the CRC is added is discarded. The MAC header analysis processing confirms whether or not the address of the Address 1 field in the MAC Header matches the MAC address of its own device (e.g., the MAC address set to the wireless link unit 310). As a result, in the case where the MAC address matches and the CRC is determined to be correct, the MAC frame of the processing target is transferred to an upper MAC (UMAC) layer unit 331 included in the control unit 330.

In addition, in a case where the MAC frame transferred from the PHY layer unit 312 is a frame requesting a response, the LMAC layer unit 313 generates a response frame. The response frame generated by the LMAC layer unit 313 is mainly a frame that requires an immediate response, and is returned after short interframe spacing (SIFS) from the end of the PPDU including the MAC frame requesting the response frame (e.g., a QoS data frame, an A-MPDU frame containing multiple QoS data frames or a Block Ack Request (BAR) frame, etc.). In the reception processing, the LMAC layer unit 313 also performs processing for retaining delivery confirmation information, which indicates that the MPDU was correctly received, in bitmap format. This bitmap information is used when returning the response frame as a Block Ack (BA) frame.

The above is the outline of the reception processing.

On the other hand, in transmission processing, the LMAC layer unit 313 generates MAC frames (e.g., data frames and control frames such as Block Ack (BA), Acknowledge (ACK), Block Ack Request (BAR), etc.). In the LMAC layer unit 313, a Carrier Sense Multiple Access With Collision Avoidance (CSMA/CA) method to determine whether or not to transmit a MAC frame is used after confirming the usage status of a wireless channel, such as a status on whether or not another wireless communication device is transmitting a wireless signal. If the wireless channel is not in use for the period of time specified in the IEEE 802.11 standard, the LMAC layer unit 313 determines that no other wireless communication device is transmitting wireless signals, and transfers the MAC frame to the PHY layer unit 312 to start transmission. On the other hand, if the wireless channel is in use (busy), the transmission is postponed until it becomes an unused (idle) state.

When the MAC frame is transferred from the LMAC layer unit 313 to the PHY layer unit 312, the modulator included in the PHY layer unit 312 performs, for example, transmission processing including a predetermined modulation and code processing with respect to the MAC frame in accordance with the IEEE 802.11 standard (including IEEE 802.11a, IEEE 802.11b, IEEE 802.11g, IEEE 802.11n, IEEE 802.11ac, IEEE 802.11ax, IEEE 802.11be, and 802.11 standards to be defined in the future). The digital signal is then converted to an analog baseband signal by a digital-to-analog converter (DAC), and the baseband signal is input to the wireless transmitter. The wireless transmitter frequency-converts (up-converts) the input baseband signal into a predetermined frequency band (e.g., 2.4 GHz, 5 GHz, or 6 GHz band frequency) using a carrier signal generated by the oscillator, and transmits the frequency-converted signal as a wireless signal from the antenna via the antenna switch.

In the transmission processing, the LMAC layer unit 313 performs CRC calculation processing, aggregation processing, etc. The LMAC layer unit 313 calculates the CRC of the MAC frame transferred from the UMAC layer unit 331, which will be described in detail later, and transfers an MPDU frame, in which the calculation result of the CRC is included in the FCS field added last to the MAC frame, to the PHY layer unit 312. The LMAC layer unit 313 also generates an A-MPDU frame in which a plurality of MPDUs are connected as necessary, for example, to achieve high-speed throughput, and transfers this to the PHY layer unit 312. As described above, the LMAC layer unit 313 may also generate response frames such as Ack frames and BA frames, and transfer them to the PHY layer unit 312.

The above is the outline of the transmission processing.

The control unit 330 performs the control necessary for operating the plurality of wireless link units 110 and 320. For example, the control unit 330 sets the frequency channel and frequency bandwidth for operating each of the wireless link units 210 and 320. The control unit 330 includes the UMAC layer unit 331. In the transmission processing, the UMAC layer unit 331 generates a sequence number to be assigned to each MPDU and encrypts the MPDUs. In the reception processing, the UMAC layer unit 331 performs decryption processing of the encrypted MPDUs, reordering processing of the MPDUs in the order of the sequence number, and so on.

The wired I/F unit 343 has functions for receiving data from and transmitting data to other devices, for example, using Ethernet as a wired communication method. As other wired communication functions, peripheral component interconnect-express (PCIe), universal serial bus (USB), secure digital input/output (SDIO), serial peripheral interface (SPI), universal asynchronous receiver/transmitter (UART), and the like may be used. The wired I/F unit 343 may be omitted if there is no need for a wired connection to a device external to the wireless communication device.

The memory 342 is configured by a data storage device such as a static random access memory (SRAM) or a dynamic random access memory (DRAM). The memory 342 is used to temporarily store transmitted and received data transferred between the wired I/F unit 343 and the control unit 330, and to store data for processing by the processor 341.

The processor 341 is, for example, a central processing unit (CPU) or a micro processor unit (MPU), and has a function of executing predetermined instruction codes. The processor 311 also controls the wireless link units 310 and 320, the control unit 330, the wired I/F unit 343, and the like. Furthermore, the processor 341 controls the transfer of transmitted and received data between the wired I/F unit 343 and the control unit 330.

In FIG. 3, a configuration in which the wireless communication device 300 includes two wireless link units 310 and 320 is explained. However, the wireless communication device 300 is not limited thereto, and may include three or more wireless link units. In this case, each of the wireless link units may communicate using a different frequency channel or the same frequency channel.

Furthermore, in FIG. 3, a configuration in which the wireless link units 310 and 320 are each connected to one antenna (antennas 311 and 321) is explained. However, the wireless link units 310 and 320 are not limited thereto, and may each be connected to a plurality of antennas. In the case of being connected to a plurality of antennas, wireless communications may be performed using the multiple input multiple output (MIMO) method, in which different data streams are spatially multiplexed for transmission and reception.

The LMAC layer units 313 and 323, and the UMAC layer unit 331 shown in FIG. 3 each have a MAC address. A different MAC address is set for each of the LMAC layer units 313 and 323. On the other hand, for the UMAC layer unit 331, the same MAC address as one of the LMAC layer units 313 and 323, or a MAC address that is different from both the LMAC layer units 313 and 323 may be set.

Each unit included in the wireless communication device 300 may be realized as an analog circuit or a digital circuit, etc., or may be realized by software, etc., executed by a central processing unit (CPU). The wireless communication device 300 may also be implemented in one large scale integration (LSI), or the control unit 330, the processor 341, the memory 342, and the wired I/F unit 343 may be implemented in one LSI, and the wireless I/F link units 310 and 320 may be implemented in another LSI. Alternatively, only the wireless transmitter, the wireless receiver, and the antenna switch configuring the PHY layer units 312 and 322 may be implemented in a separate integrated circuit (IC).

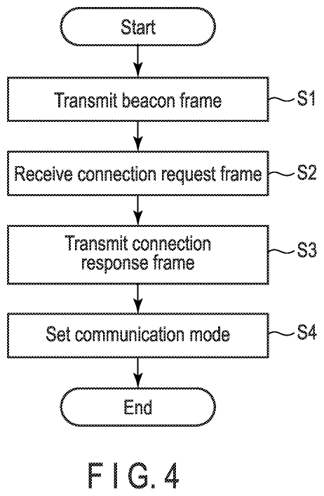

Now, with reference to the flowchart in FIG. 4, a processing procedure executed by the wireless base station AP MLD to establish a wireless connection with the wireless terminal STA MLD in a multi-link mode will be described.

First, the wireless base station AP MLD periodically (e.g., every 100 ms) transmits a beacon frame, which is one of the management frames, as a broadcast frame (step S1). According to this, information such as the communication capability supported by the wireless base station AP MLD is notified to the wireless terminal STA MLD.

The wireless base station AP MLD then receives a connection request frame (e.g., an Association Request frame) transmitted from the wireless terminal STA MLD (step S2).

In the case where the wireless base station AP MLD permits the connection of the wireless terminal STA MLD, the wireless base station AP MLD transmits a connection response frame (e.g., an Association Response frame) containing information to permit the connection to the wireless terminal STA MLD (step S3).

Then, in accordance with communication mode request included in the connection request frame transmitted from the wireless terminal STA MLD, the wireless base station AP MLD sets a communication mode in the case of communicating with the wireless terminal STA MLD (e.g., a mode in which the wireless base station AP MLD performs highly reliable communication alone, a mode in which the wireless base station AP MLD performs highly reliable communication in cooperation with multiple wireless base stations AP MLD, etc.) (step S4), and ends the series of processing here.

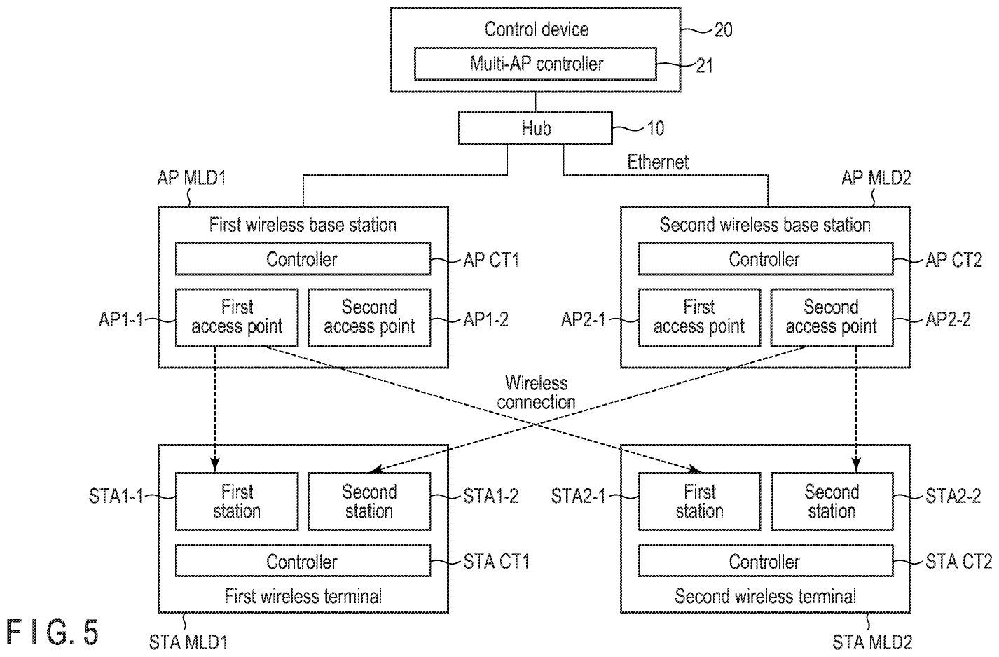

FIG. 5 is a block diagram showing a schematic configuration example of the wireless communication system according to the present embodiment. As previously described with the description of FIG. 1, the wireless communication system according to the present embodiment comprises the first wireless base station AP MLD1, the second wireless base station AP MLD2, the first wireless terminal STA MLD1, the second wireless terminal STA MLD2, and the control device 20. The first wireless base station AP MLD1 and the second wireless base station AP MLD2 are wired to the control device 20 via the hub 10. The control device 20 comprises a multi-AP controller 21 that controls the operation of the control device 20.

The first wireless base station AP MLD1 operating as an AP MLD includes a first access point AP1-1, a second access point AP1-2, and a controller AP CT1 that controls the operation of the first wireless base station AP MLD1. The first access point AP1-1 and the second access point AP1-2 correspond to the wireless link units 310 and 320 of the wireless communication device 300 shown in FIG. 3. The controller AP CT1 corresponds to the control unit 330 of the wireless communication device 300 shown in FIG. 3. Similarly, the second wireless base station AP MLD2 operating as an AP MLD includes a first access point AP2-1, a second access point AP2-2, and a controller AP CT2 that controls the operation of the second wireless base station AP MLD2. The first access point AP2-1 and the second access point AP2-2 correspond to the wireless link units 310 and 320 of the wireless communication device 300 shown in FIG. 3. The controller AP CT2 corresponds to the control unit 330 of the wireless communication device 300 shown in FIG. 3. Note that, the PHY layer unit 312 included in the wireless link unit 310 and antenna 311 may be referred to as the wireless unit. The PHY layer unit 322 included in the wireless link unit 320 and antenna 321 may be referred to as the wireless unit. The LMAC layer units 313 and 323 included in the wireless link units 310 and 320 may be referred to as the processing unit.

The first wireless terminal STA MLD1 operating as a non-AP MLD includes a first station STA1-1, a second station STA1-2, and a controller STA1 CT1 that controls the operation of the first wireless terminal STA MLD1. The first station STA1-1 and the second station STA1-2 correspond to the wireless link units 210 and 320 of the wireless communication device 300 shown in FIG. 3. The controller STA CT1 corresponds to the control unit 330 of the wireless communication device 300 shown in FIG. 3. Similarly, the second wireless terminal STA MLD2 operating as a non-AP MLD includes a first station STA2-1, a second station STA2-2, and a controller STA CT2 that controls the operation of the second wireless terminal STA MLD2. The first station STA2-1 and the second station STA2-2 correspond to the wireless link units 310 and 320 of the wireless communication device 300 shown in FIG. 3. The controller STA CT2 corresponds to the control unit 330 of the wireless communication device 300 shown in FIG. 3.

In the following, assuming a more specific situation, a case will be described in which the first access point AP1-1 included in the first wireless base station AP MLD1 transmits a beacon frame to the wireless terminal STA MLD, and the first wireless terminal STA MLD1 receiving the beacon frame performs a Multi-Link operation (which may be referred to as a Multi-AP Multi-Link operation) to connect with both the first wireless base station AP MLD1 and the second wireless base station AP MLD2, which is capable of operating in cooperation with the first wireless base station AP MLD1.

The first access point AP1-1 included in the first wireless base station AP MLD1 periodically transmits a beacon frame, which is one of the management frames, to the wireless terminal STA MLD as a broadcast frame.

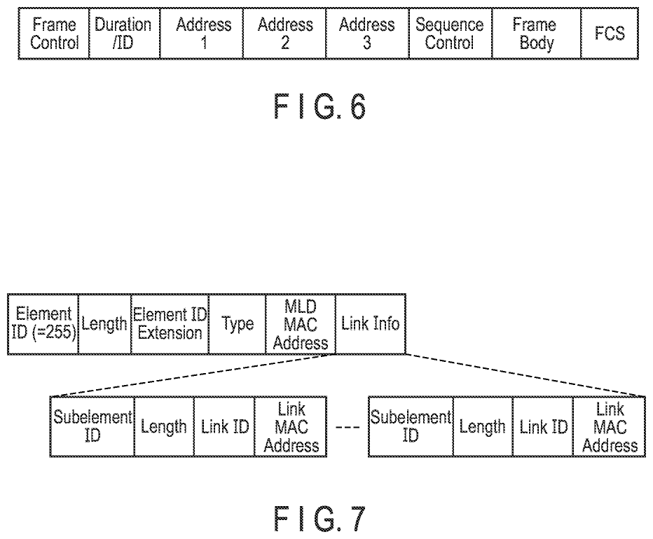

Here, with reference to FIG. 6, the beacon frame broadcasted from the first access point AP1-1 included in the first wireless base station AP MLD1 to the wireless terminal STA MLD will be described.

FIG. 6 shows a frame format of the beacon frame. As shown in FIG. 6, the beacon frame is configured by a Frame Control field, a Duration/ID field, an Address 1 field, an Address 2 field, an Address 3 field, a Sequence Control field, a Frame Body field, and an FCS field. The roles of the fields other than the Frame Body field are the same as those of the MAC frame described in FIG. 2. Therefore, detailed descriptions thereof are omitted here.

To the Type and Subtype fields of the Frame Control field is assigned a bit pattern (e.g., Type=2′b00, Subtype=4′b1000, etc.) indicating that the frame is a beacon frame. The Duration/ID field is set to 0.

All Address 1 fields are set to 1 (specifically, 48′hFFFF_FFFF) to indicate that the beacon frame is transmitted as a broadcast frame. In the Address 2 field, the MAC address of the transmitting station is set. Here, since a case in which the first access point AP1-1 in the first wireless base station AP MLD1 transmits a beacon frame is assumed, the MAC address of the transmitting station is set in the Address 2 field. Note that, in a case where the second access point AP1-2 included in the first wireless base station AP MLD1 transmits a beacon frame, the MAC address of the second access point AP1-2 is set in the Address 2 field. A BSSID is set in the Address 3 field. Here, since it is assumed that the BSSID is the same as that of the first access point AP1-1 transmitting the beacon frame, the MAC address of the first access point AP1-1 is set in the Address 3 field. As the sequence number of the Sequence Control field, a value that is incremented by one each time a beacon frame is transmitted is set.

In the Frame Body field, multiple pieces of information relating to the first wireless base station AP MLD1 are set. For example, the information includes the time at which the beacon frame is transmitted, a transmission cycle time of the beacon frame, PHY rate information supported by the first wireless base station AP MLD1, and the like. To this Frame Body field, information relating to a multi-link operation of the first wireless base station AP MLD1 (Multi-Link element) and information relating to a frequency channel (Reduced Neighbor Report element) are added.

FIG. 7 shows a field configuration example of the Multi-Link element. As shown in FIG. 7, the Multi-Link element is configured by an Element ID field, a Length field, an Element ID Extension field, a Type field, an MLD MAC Address field, and a Link Info field.

In the Element ID field, an identifier of the Multi-Link element is set. In the Length field, information indicating the length from the Element ID Extension field to the Link Info field is set in octets. In the Element ID Extension field, an identifier indicating that the element is a Multi-Link element is set. In the Type field, information indicating the type of Multi-Link element is set. In the MLD MAC Address field, a MAC address of a configuration corresponding to the UMAC layer unit is set, and MAC addresses of the first wireless base station AP MLD1, the wireless base station that can operate in cooperation with the first wireless base station AP MLD1 (in this case, the second wireless base station AP MLD2), and the control device 20 that is wired to the first wireless base station AP MLD1 are set.

The Link Info field is set with information for identifying a configuration (wireless link unit) corresponding to the LMAC layer unit included in the first wireless base station AP MLD1 and the wireless base station that can operate in cooperation with the first wireless base station AP MLD1 (in this case, the second wireless base station AP MLD2). More specifically, the Link Info field includes a Subelement ID field, a Length field, a Link ID field, and a Link MAC Address field.

In the Subelement ID field, an identifier of a subelement is set. In the Length field, information indicating the length from the Link ID field to the Link MAC Address field is set in octets. In the Link ID field, an identifier for identifying a configuration (wireless link unit) corresponding to the LMAC layer unit is set. In the Link MAC Address, a MAC address of a configuration (wireless link unit) corresponding to the LMAC layer unit is set.

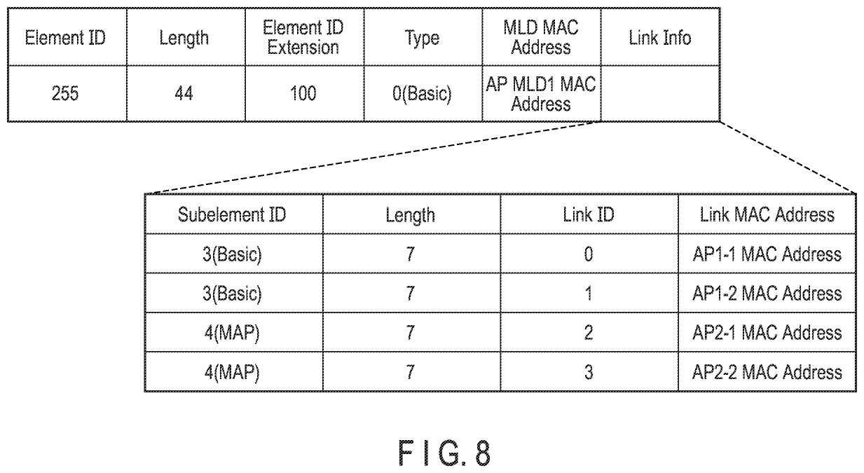

FIG. 8 shows an example of setting values set for each field that configures the Multi-Link element. As shown in FIG. 8, in the Element ID field, a value “255” indicating that an Element ID Extension field is added subsequently is set. In the Length field, a value “44” is set, which indicates a case in which, for example, four subelements are included in the Link Info field. In the Element ID Extension field, as an example, a value “100” is set. In the Type field, value “0” is set to indicate that the element is a basic type. In the MLD MAC Address, the MAC address of the first wireless base station AP MLD1 is set. The Link Info field includes four subelements as described above.

As show in FIG. 8, the first Link Info field includes: a Subelement ID in which a value “3” indicating that the element is a Basic variant Multi-Link element is set; a Length field in which a value “7” indicating the length from the Link ID field to the Link MAC Address is set; a Link ID field in which an identifier “0” is set to identify the first access point AP1-1 included in the first wireless base station AP MLD1; and a Link MAC Address field in which the MAC address of the first access point AP1-1 is set.

The second Link Info field includes: a Subelement ID in which a value “3” indicating that the element is a Basic variant Multi-Link element is set; a Length field in which a value “7” indicating the length from the Link ID field to the Link MAC Address is set; a Link ID field in which an identifier “1” is set to identify the second access point AP1-2 included in the first wireless base station AP MLD1; and a Link MAC Address field in which the MAC address of the second access point AP1-2 is set.

Furthermore, the third Link Info field includes: a Subelement ID in which a value “4” indicating that the element is a Multi-AP variant Multi-Link element is set; a Length field in which a value “7” indicating the length from the Link ID field to the Link MAC Address is set; a Link ID field in which an identifier “2” is set to identify the first access point AP2-1 included in the second wireless base station AP MLD2; and a Link MAC Address field in which the MAC address of the first access point AP2-1 is set.

In addition, the fourth Link Info field includes: a Subelement ID in which a value “4” indicating that the element is a Multi-AP variant Multi-Link element is set; a Length field in which a value “7” indicating the length from the Link ID field to the Link MAC Address is set; a Link ID field in which an identifier “3” is set to identify the second access point AP2-2 included in the second wireless base station AP MLD2; and a Link MAC Address field in which the MAC address of the second access point AP2-2 is set.

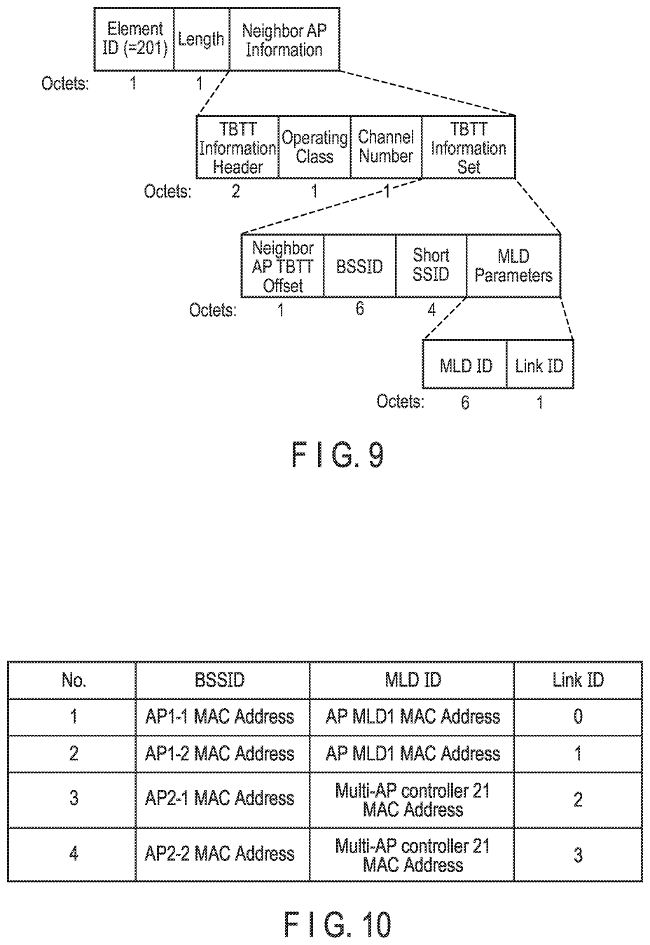

Subsequently, with reference to FIG. 9, a field configuration example of a Reduced Neighbor Report element will be described. The Reduced Neighbor Report element includes information for mapping frequency channel numbers used by each wireless link unit in the first wireless base station AP MLD1 and a wireless base station that can operate in cooperation with the first wireless base station AP MLD1 (in this case, the second wireless base station AP MLD2).

As shown in FIG. 9, the Reduced Neighbor Report element is configured by an Element ID field, a Length field, and a Neighbor AP Information field. In the Element ID field, an identifier of the Reduced Neighbor Report element is set.

As shown in FIG. 9, the Neighbor AP Information field includes a TBTT Information Header, an Operating Class field, a Channel Number field, and a TBTT Information Set field.

In a wireless communication system compliant with the IEEE 802.11 standard, the location of a center frequency on a frequency can be grasped by a channel number. The channel number is assigned at 5 MHz intervals of the center frequency. This value is set in the Channel Number field. The Operating Class field is set with information that conforms a channel width to the usage rules in each country or region. According to the Channel Number field and the Operating Class field, it is possible to grasp which frequency location and channel width are being used to operate (the access point included in) the base station.

As shown in FIG. 9, the TBTT information Set field can include a BSSID field to notify a BSSID, which is an identifier of the BSS, or a Short-SSID field to confirm an SSID, which is a service identifier of the wireless communication system, etc.

The TBTT Information Header is set with, for example, information for identifying whether or not fields such as the BSSID field and the Short-SSID field are included in the subsequent fields. According to this, the wireless terminal STA MLD receiving the beacon frame can recognize whether or not a MLD Parameters field described later is added to the subsequent fields.

As shown in FIG. 9, the MLD Parameters field can be added to the TBTT Information Set field. As shown in FIG. 9, the MLD Parameters field includes an MLD ID field and a Link ID field. In the MLD ID field, an identifier that can identify the MLD (i.e., a configuration corresponding to the UMAC layer unit), such as the MAC address of the wireless base station AP MLD, is set. In the Link ID field, an identifier that can identify the wireless link unit (i.e., a configuration corresponding to the LMAC layer unit) is set, which is, for example, the same value as that in the Link ID field included in the Link Info field of the Multi-Link element.

As the main parameters included in the Reduced Neighbor Report element, FIG. 10 shows an example of the setting values set for the BSSID field, the MLD ID field, and the Link ID field. Note that, here, a case in which the beacon frame includes a Reduced Neighbor Report element that includes four Neighbor AP Information fields is assumed. Alternatively, a case in which the beacon frame includes four Reduced Neighbor Report elements may also be assumed.

For example, the first Neighbor AP Information field includes: a BSSID field in which the MAC address of the first access point AP1-1 is set; an MLD ID field in which the MAC address of the first wireless base station AP MLD1 is set; and a Link ID field in which an identifier “0” is set to identify the first access point AP1-1 included in the first wireless base station AP MLD1.

In addition, the second Neighbor AP Information field includes: a BSSID field in which the MAC address of the second access point AP1-2 is set; an MLD ID field in which the MAC address of the first wireless base station AP MLD1 is set; and a Link ID field in which an identifier “1” is set to identify the second access point AP1-2 included in the first wireless base station AP MLD1.

Furthermore, the third Neighbor AP Information field includes: a BSSID field in which the MAC address of the first access point AP2-1 is set; an MLD ID field in which the MAC address of the multi-AP controller 21 is set; and a Link ID field in which an identifier “2” is set to identify the first access point AP2-1 included in the second wireless base station AP MLD2.

In addition, the fourth Neighbor AP Information field includes: a BSSID field in which the MAC address of the second access point AP2-2 is set; an MLD ID field in which the MAC address of the multi-AP controller 21 is set; and a Link ID field in which an identifier “3” is set to identify the second access point AP2-2 included in the second wireless base station AP MLD2.

When the first wireless terminal STA MLD1 receives a beacon frame including the above-mentioned Multi-Link element and the above-mentioned Reduced Neighbor Report element, based on this information, it recognizes that the first wireless base station AP MLD1 alone can perform Multi-Link operation and that the first wireless base station AP MLD1 can perform Multi-Link operation (Multi-AP Multi-Link operation) in cooperation with the second wireless base station AP MLD2.

Here, as described above, a case is assumed in which the first wireless terminal STA MLD1 performs Multi-Link operation to connect with both the first wireless base station AP MLD1 and the second wireless base station AP MLD2. However, for example, in a case where the first wireless terminal STA MLD1 chooses to perform Multi-Link operation with the first wireless base station AP MLD1 alone, the first wireless terminal STA MLD1 transmits an Association Request frame to the first access point AP1-1 requesting, for example, that the first station STA1-1 be connected to the first access point AP1-1 and the second station STA1-2 be connected to the second access point AP1-2.

In a case where the first wireless terminal STA MLD1 chooses to perform Multi-Link operation to connect with both the first wireless base station AS MLD1 and the second wireless base station AP MLD2, the first wireless terminal STA MLD1 transmits an Association Request frame to the first access point AP1-1 requesting, for example, that the first station STA1-1 be connected to the first access point AP1-1 included in the first wireless base station AP MLD1 and that the second station STA1-2 be connected to the second access point AP2-2 included in the second wireless base station AP MLD2. More specifically, the controller STA CT1 included in the first wireless terminal STA MLD1 generates an Association Request frame that includes the Multi-Link element in the Frame Body. The generated Association Request frame is transmitted by the first station STA1-1 in the first wireless terminal STA MLD1 to the first access point AP1-1 in the first wireless base station AP MLD1.

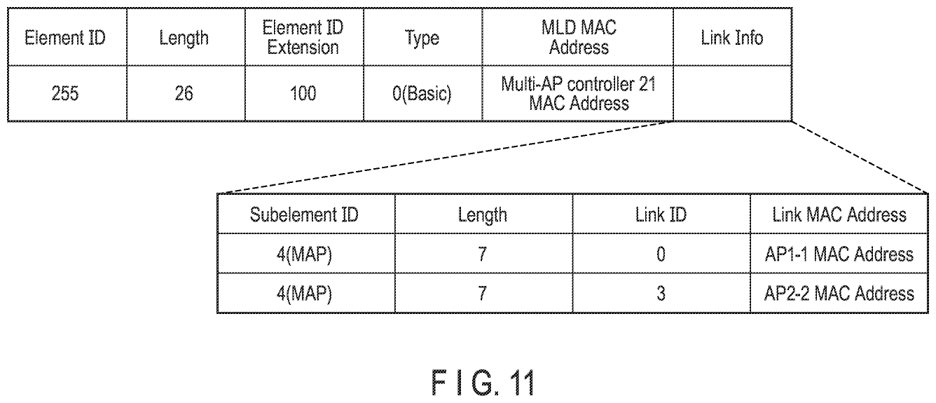

FIG. 11 shows an example of the setting values set for each field that configures the Multi-Link element included in the Association Request frame. As shown in FIG. 11, in the Element ID field, a value “255” indicating that an Element ID Extension field is added subsequently is set. In the length field, a value “26”, which is the length from the Element ID Extension field to the Link Info field in a case where, for example, the Link Info field includes two subelements, is set. Each of the Element ID Extension field and the Type field is 1 octet, the MLD MAC Address is 6 octets, each of the Subelement ID field, the Length field, and the Link ID field in the Link Info field is 1 octet, and the Link MAC Address field is 6 octets. As an example, in the Element ID Extension field, a value “100” is set. In the Type field, a value “0” indicating a Basic Type is set. In the MLD MAC Address field, the MAC address of the multi-AP controller 21 is set. The Link Info field includes two subelements as described above.

As shown in FIG. 11, the first Link Info field includes: a Subelement ID in which a value “4” indicating that the element is a Multi-AP variant Multi-Link element is set; a Length field in which a value “7”, which indicates the length from the Link ID field to the Link MAC Address, is set; a Link ID field in which an identifier “0” is set to identify the first access point AP1-1 included in the first wireless base station AP MLD1; and a Link MAC Address field in which the MAC address of the first access point AP1-1 is set.

The second Link Info field includes: a Subelement ID in which a value “4” indicating that the element is a Multi-AP variant Multi-link element is set; a Length field in which a value “7”, which indicates the length from the Link ID field to the Link MAC Address, is set; a Link ID field in which an identifier “3” is set to identify the second access point AP2-2 included in the second wireless base station AP MLD2; and a Link MAC Address field in which the MAC address of the second access point AP2-2 is set.

When the first access point AP1-1 included in the first wireless base station AP MLD1 receives the above Association Request frame, it transfers the Association Request frame to the multi-AP controller 21 included in the control device 20. Accordingly, the multi-AP controller 21 recognizes that the first wireless terminal STA MLD1 is requesting the Multi-AP Multi-Link operation to connect with both the first wireless base station AP MLD1 and the second wireless base station AP MLD2.

If there is no problem in accommodating the first wireless terminal STA MLD1, the Multi-AP Controller 21 notifies the first wireless base station AP MLD1 that the connection is permitted. When the first wireless base station AP MLD1 receives the notification that the connection is permitted from the multi-AP controller 21, it generates an Association Response frame and sets information on permitting the connection in the frame. The Association Response frame in which the information on permitting the connection is set is transmitted from the first access point AP1-1 in the first wireless base station AP MLD1 to first station STA1-1 in the first wireless terminal STA MLD1.

After the transmission of the Association Response frame is completed, the multi-AP controller 21 instructs the first wireless base station AP MLD1 and the second wireless base station AP MLD2 to accommodate the first station STA1-1 and the second station STA1-2 included in the first wireless terminal STA MLD1. Accordingly, the multi-AP controller 21, the controller AP CT1 end the controller AP CT2 set a mode in which the first wireless base station AP MLD1 and the second wireless base station AP MLD2 cooperate to perform highly reliable communication with the first wireless terminal STA MLD1.

Note that, here, a case is described in which the first wireless terminal STA MLD1 transmits an Association Request frame to the first wireless base station AP MLD1, requesting that the first station STA1-1 be connected to the first access point AP1-1 included in the first wireless base station AP MLD1, and that the second station STA1-2 be connected to the second access point AP2-2 included in the second wireless base station AP MLD2, for the first wireless terminal STA MLD1 to establish wireless connection with the first wireless base station AP MLD1 and the second wireless base station AP MLD2. However, by the same procedure, the second wireless terminal STA MLD2 can also transmit an Association Request frame to the second wireless base station AP MLD2, requesting that the first station STA2-1 be connected to the first access point AP1-1 included in the first wireless base station AP MLD1 and that the second station STA2-2 be connected to the second access point AP2-2 included in the second wireless base station AP MLD2, for the second wireless terminal STA MLD2 to establish wireless connection with the first wireless base station AP MLD1 and the second wireless base station AP MLD2.

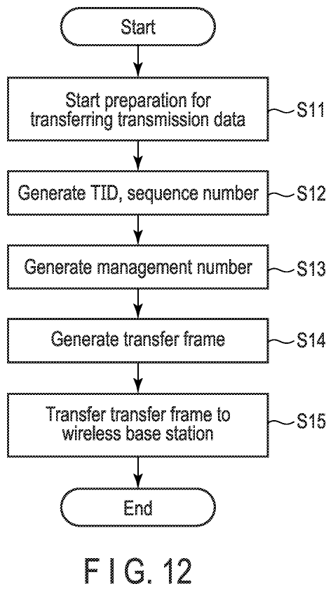

Now, with reference to the flowchart in FIG. 12, a processing procedure up to where the multi-AP controller 21 transfers transmission data addressed to the first wireless terminal STA MLD1 to the first wireless base station AP MLD1 and the second wireless base station AP MLD2 will be described. The series of processing shown in FIG. 12 takes place, for example, after the first wireless terminal STA MLD1 has established wireless connection with both the first wireless base station AP MLD1 and the second wireless base station AP MLD2.

First, in a case where the data generated in the control device 20 or transferred from outside the control device 20 is addressed to the first wireless terminal STA MLD1, the multi-AP controller 21 starts preparations to transfer the data (transmission data) to the first wireless base station AP MLD1 and the second wireless base station AP MLD2 (step S11). Note that the data to be transferred to the wireless base station AP MLD is, for example, an Internet Protocol (IP) packet, which includes User Datagram Protocol (UDP) data or Transmission Control Protocol (TCP) data, etc.

The multi-AP controller 21 then generates a TID and a sequence number for the transmission data to be transferred to the first wireless base station AP MLD1 and the second wireless base station AP MLD2 (step S12).

The TID is determined according to the type of the transmission data to be transferred. Therefore, if the type of the transmission data is the same, the value of the TID is also the same. On the other hand, the sequence number is incremented by one for each transmission data to be transferred. The number of bits in the sequence number is, for example, 12 bits, and the sequence number takes one of the values from 0 to 4095. Note that, in a case where the sequence number reaches 4095, the sequence number returns to 0 again and is assigned to the next transmission data. The sequence number is assigned to each destination device and each TID. In other words, in the case where one of the destination device or the TID is different, a sequence number that is incremented separately from the sequence number for the destination device and the TID is assigned.

In the case where the wireless base station AP MLD generates a MAC frame based on the transmission data transferred from the multi-AP controller 21, the TID and the sequence number will be set in (the TID field included in) the QoS Control field and the Sequence Control field in the MAC header, respectively, as described in detail below.

After the processing in step S12, the multi-AP controller 21 generates a management number to manage the transmission data (MSDU: MAC Service Data Unit) that is transferred to the first wireless base station AP MLD1 and the second wireless base station AP MLD2 (step S13). The MSDU includes, for example, an IP packet.

The management number is a number that is incremented for each transmission data (MSDU) that is transferred to the wireless base station AP MLD. In a case where transmission data in which the value of at least one of the destination device, TID, and sequence number is different from the other transmission data is transferred to the wireless base station AP MLD, the management number is incremented by one.

The number of bits of the management number is, for example, 32 bits. However, the management number assigned to the transmission data that has already been transmitted from the wireless base station AP MLD to the destination device (wireless terminal STA MLD) is a number that has already completed its role and is used again as the management number for new data. In other words, the management number only needs to be unique within a certain period of time, and the number of bits of the management number may be the number of bits other than the 32 bits described above. For example, the number of bits of the management number may be determined according to the number of wireless terminals managed by the multi-AP controller 21, the transfer rate of the data transmitted within a certain period of time, and the like.

After the processing in step S13, the multi-AP controller 21 generates an Ethernet frame (transfer frame, transfer packet) including the TID and sequence number generated in the processing in step S12, the management number generated in the processing in step S13, and the transmission data to be transferred.

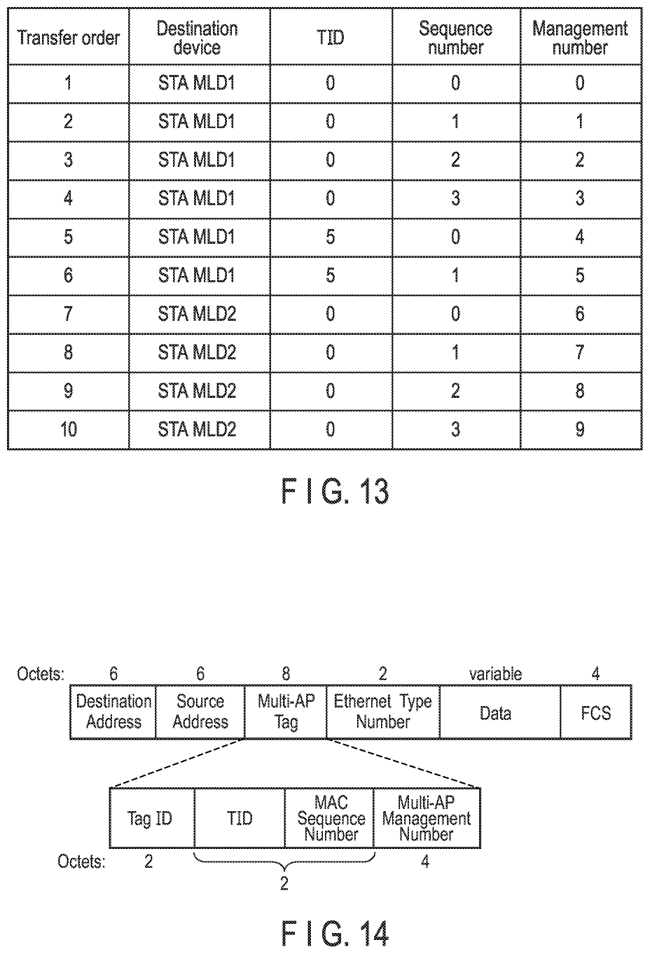

Here, with reference to FIG. 13, an example of the settings of the TID, sequence number, and management number included in the transfer frame generated by the processing of step 314 above is described. Here, for example, transfer frames in which transfer orders are “1” and “2” are focused. As shown in FIG. 13, the transfer frame in which the transfer order is “1” and the destination device is “first wireless terminal STA MLD1” includes TID “0”, sequence number “0”, and management number “0” in association with each other. In addition, the transfer frame in which the transfer order is “2” and the destination device is “first wireless terminal STA MLD1” includes TID “0”, sequence number “1”, and management number “1” in association with each other. Since both of the TIDs included in these two transfer frames indicate “0”, the type of the transmission data to be transferred in these two transfer frames is considered to be the same. On the other hand, since the sequence numbers included in these two transfer frames indicate different values, it is considered that the transmission data itself to be transferred included in the two transfer frames is different. As mentioned above, since the management number is a value that is incremented by one in the case where any one of the destination device, the TID, or the sequence number is different, the management numbers included in these two transfer frames each indicate different values.

Note that, here, although the transfer frames in which the transfer orders are “1” and “2” are given as examples, the same explanation can be applied to the transfer frames in which the transfer orders are “3” to “10”.

Furthermore, with reference to FIG. 14, the frame format of the transfer frame (Ethernet frame) generated by the processing in step S14 above will be described. FIG. 14 shows the frame format of the Ethernet frame. As shown in FIG. 11, the Ethernet frame is configured by a Destination Address field, a Source Address field, a Multi-AP Tag field, en Ethernet Type Number field, a Data field, and an FCS field.

In the Destination Address field, the MAC address of the destination device is set. In the Source Address field, the MAC address of a transmission source device is set. The Multi-AP Tag field is set with accompanying information of a case in which transmission data is transferred from the multi-AP controller 21 to the controller AP CT included in the wireless base station AP MLD. The Ethernet Type Number field is set with an identifier of an upper layer protocol to be stored in the subsequent Data field. In the Data field, transmission data such as an IP packet is stored. In the FCS field, the CRC calculated based on the Destination Address field to the Data field is set.

As shown in FIG. 14, the Multi-AP Tag field includes a Tag ID field, a TID field, a MAC Sequence Number field, and a Multi-AP Management Number field. In the Tag ID field, an identifier indicating that it is a Multi-AP Tag is set. The TID field has a length of 4 bits, for example, and contains a TID. The MAC Sequence Number field has a length of 12 bits, for example, and contains a sequence number. The Multi-AP Management Number field has a length of 32 bits, for example, and contains a management number.

Now, returning to the description of FIG. 12 again, after the processing in step S14, a wired I/F unit (not shown) included in the control device 20 transfers the Ethernet frame (transfer frame) generated by the Multi-AP controller 21 to the first wireless base station AP MLD1 and the second wireless base station AP MLD2 (step S15), and ends the series of processing here.

In the present embodiment, a case in which the first wireless base station AP MLD1 and she second wireless base station AP MLD2 cooperate to perform highly reliable communication with the first wireless terminal STA MLD1 is assumed. Therefore, an Ethernet frame including the same transmission data is transferred to the first wireless base station AP MLD1 and the second wireless base station AP MLD2. In this case, by setting a broadcast address in the Destination Address field that configures the Ethernet frame, the transfer may be performed for both the first wireless base station AP MLD1 and the second wireless base station AP MLD2 in one step. Alternatively, the MAC address of the wired I/F unit of the first wireless base station AP MLD1 and the MAC address of the wired I/F unit of the second wireless base station AP MLD2 may be set in the Destination Address field that configures the Ethernet frame, to perform transmission in two steps. Note that the Destination Address field may contain a multicast address or a unicast address.

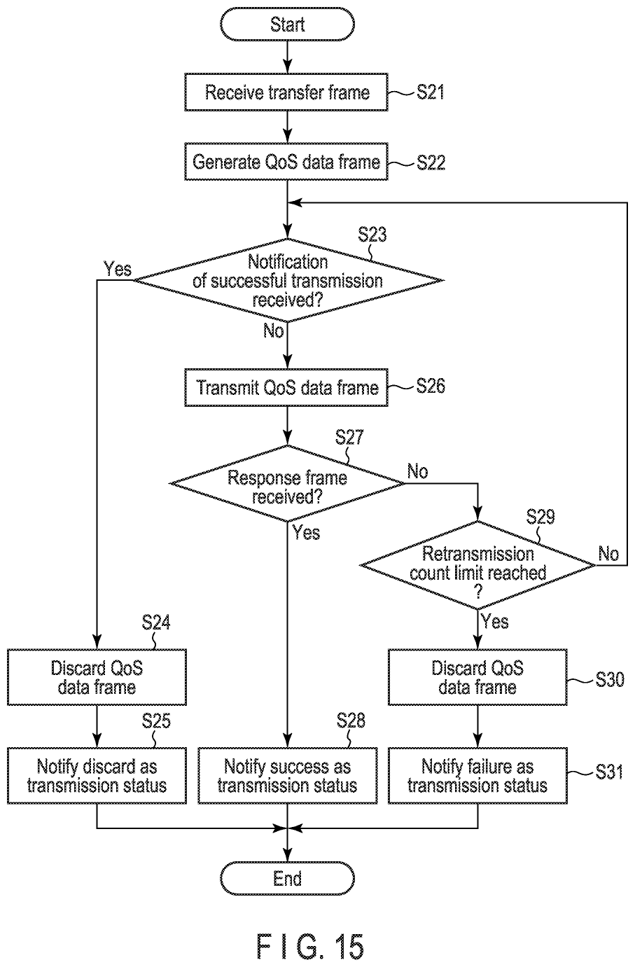

Now, with reference to the flowchart in FIG. 15, a processing procedure in which the first wireless base station AP MLD1 transmits the transmission data to the first wireless terminal STA MLD1 will be described.

First, when the first wireless base station AP MLD1 receives (accepts) the Ethernet frame (transfer frame) transferred from the control device 20, it extracts the TID, the sequence number, and the management number from the Multi-AP Tag field that configures the Ethernet frame (step S21). The extracted TID, sequence number, and management number are temporarily stored in the memory in association with the transmission data stored in the subsequent Data field that configures the received Ethernet frame.

Then, the controller AP CT1 of the first wireless base station AP MLD1 generates a QoS data frame, which is a MAC frame, by setting the TID and the sequence number extracted by the processing in step S21 to (the TID field included in) the QoS Control field and the Sequence Control field in the MAC Header, respectively, and setting the transmission data stored in the Data field to the Frame Body field (step S22).

In the present embodiment, a case is assumed in which the first station STA1-1 is connected to the first access point AP1-1 included in the first wireless base station AP MLD1, and the second station STA1-2 is connected to the second access point AP1-2 included in the second wireless base station AP MLD2. Therefore, in the QoS data frame generated by the first wireless base station AP MLD1, an Address 1 field is set with the MAC address of the first station STA1-1 included in the first wireless terminal STA MLD1, an Address 2 field is set with the MAC address of the first access point AP1-1 included in the first wireless base station AP MLD1, and an Address 3 field is set with the MAC address of the first access point AP1-1 in the same manner as the Address 2 field. Note that, by the same processing as in steps S21 and S22 above, in the QoS data frame generated by the second wireless base station AP MLD2, an Address 1 field is set with the MAC address of the second station STA1-2 included in the first wireless terminal STA MLD1, an Address 2 field is set with the MAC address of the second access point AP2-2 included in the second wireless base station AP MLD2, and an Address 3 field is set with the MAC address of the second access point AP2-2 in the same manner as the Address 2 field.

After the processing in step S22, the first wireless base station AP MLD1 confirms whether or not a notification has been received from the second wireless base station AP MLD2 operating in cooperation therewith, notifying successful transmission of the QoS data frame including transmission data that is given the same management number as the management number of the transmission data stored in the Data field of the QoS date frame generated by the processing step S22 (step S23).

As a result of the processing in step S23, in the case where it is confirmed that the notification of successful transmission of the QoS data frame including the transmission data with the same management number is received (Yes in step S23), the controller AP CT1 of the first wireless base station AP MLD1 discards the QoS data frame generated by the processing in step S22 (step S24), and transmits a notification that the QoS data frame has been discarded at least to the multi-AP controller 21 included in the control device 20 (step S25).

On the other hand, as a result of the processing in step S23, in the case where it is confirmed that the notification of successful transmission of the QoS data frame including the transmission data with the same management number is not received (No in step S23), the first access point AP1-1 of the first wireless base station AP MLD1 transmits the QoS data frame including the transmission data to the first station STA1-1 of the first wireless terminal STA MLD1 (step S26).

Subsequently, the first access point AP1-1 of the first wireless base station AP MLD1 confirms whether or not a response frame (such as an Ack frame or a BA frame) has been received from the first station STA1-1 of the first wireless terminal STA MLD1 (step S27). As a result of the processing in step S27, in the case where it is confirmed that the response frame has been received (Yes in step S27), the controller AP CT1 of the first wireless base station AP MLD1 generates a UDP packet including information indicating that the transmission of the QoS data frame was successful and the management number of the transmission data stored in the QoS data frame. Subsequently, the controller AP CT1 generates an IP packet including the generated UDP packet, and transmits the Ethernet frame in which the Ethernet header is added to the IP packet to at least one of the multi-AP controller 21 of the control device 20 and the second wireless base station AP MLD2 (step S28).

A broadcast address (e.g., ff.ff.ff.ff.ff.ff), for example, is set as a destination MAC address in the Ethernet header described above, and the MAC address of the wired I/F unit in the first wireless base station AP MLD1, for example, is set as a transmission source MAC address in the Ethernet header. Furthermore, an IP address of the first wireless base station AP MLD1, for example, is set as a transmission source IP address in the IP header mentioned above, and a broadcast address (e.g., 255.255.255.255), for example, is set as a destination IP address in the IP header. In addition, an appropriate number (e.g. 49155) that does not overlap with other communications is set as a transmission source port number in the UDP header mentioned above, and a number (e.g. 20400) that has been negotiated in advance with the second wireless base station AP MLD2 is set as a destination port number in the UDP header. The transmission result in the UDP data is indicated by one of the following values: “0” indicating transmission success, “1” indicating transmission failure, or “2” indicating discard. According to this, since the Ethernet frames and IP packets are transmitted from the wired I/F unit in the first wireless base station AP MLD1 as broadcast frames, they can be transmitted to both the multi-AP controller 21 and the second wireless base station AP MLD2. In the case where the second wireless base station AP MLD2 receives the above-mentioned UDP packet, it confirms the destination port number. If the destination port number is a number negotiated in advance, it recognizes the UDP packet as a notification of the transmission result, and therefore can extract the management number and the transmission result from the data field in the UDP packet. In the case where the transmission result is “success”, a search is performed on whether or not a QoS data frame including the transmission data with the same management number as the extracted management number exists as a frame to be transmitted. In the case where such a QoS data frame exists as a frame to be transmitted, the transmission of the frame can be stopped and discarded.

On the other hand, as a result of the processing in step S27, in a case where a certain period of time has passed and a response timeout has occurred without being able to confirm that a response frame has been received (No in step S27), the first access point AP1-1 of the first wireless base station AP MLD1 confirms whether or not the number of transmissions of the QoS data frame has reached a retransmission count limit (step S29). As a result of the processing in step S29, in a case where it is confirmed that the number of transmissions of the QoS data frame has not reached the retransmission count limit (No in step S29), the processing in step S23 described above is executed again.

On the other hand, as a result of the processing in step S29, in a case where it is confirmed that the number of transmissions of the QoS data frame has reached the retransmission count limit (Yes in step S29), the first access point AP1-1 of the first wireless base station AP MLD1 gives up retransmission of the QoS data frame generated by the processing in step S22, and discards the QoS data frame (step S30).

Then, the controller AP CT1 of the first wireless base station AP MLD1 transmits a notification that the transmission of the transmission data stored in the QoS data frame has failed to at least the multi-AP controller 21 of the control device 20 (step S31), and ends the series of processing here.

According to the first embodiment described above, the wireless base station AP MLD can identify whether or not the other wireless base station AP MLD performing the Multi-Link operation in cooperation with the wireless base station AP MLD has been successful in transmitting the transmission data based on the management number assigned to the transmission data transferred from the control device 20. For example, in the case where a plurality of wireless terminals STA MLDs are wirelessly connected to a wireless base station AP MLD, and the same frame is to be transmitted to one wireless terminal STA MLD via multiple wireless base stations AP MLDs, the wireless base station AP MLD can identify whether or not transmission data is the same as the transmission data that has already been successfully transmitted by another wireless base station AP MLD, and can discard the transmission data. Accordingly, since unnecessary frame transmissions can be suppressed while new frame transmissions can be promoted, it is possible to achieve efficient communication using the multi-link transmission technology.

In the following, a modified example of the first embodiment is described.

### Modified Example of First Embodiment

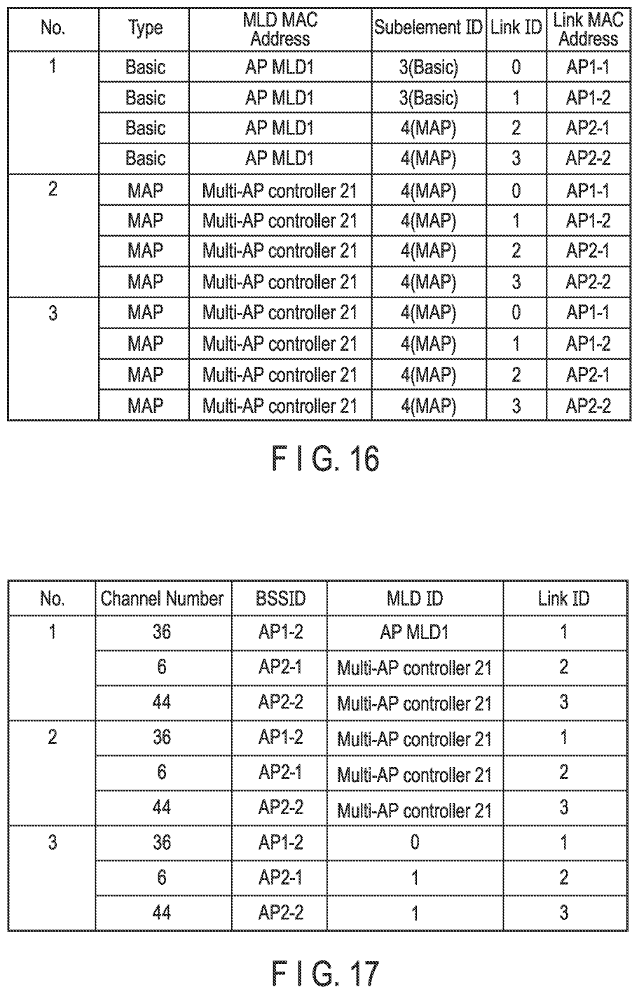

FIG. 16 shows an example of the setting values set for each field that configures the Multi-Link element included in the beacon frame, and FIG. 17 shows an example of the setting values set for each field that configures the Reduced Neighbor Report element included in the beacon frame. FIG. 16 and FIG. 17 show only the main parameters of each element.

The modified example describes a case where all the setting values for the same No. are included in a beacon frame.

For example, in the setting value of No. “1” shown in FIG. 16 and FIG. 17, the Type field is set to a value “0” indicating that it is a Basic Type, while the Subelement ID field set to a value “4” indicating that it is a Multi-AP variant Multi-Link element. In other words, the setting value of No. “1” corresponds to a setting example in a case where the first wireless base station AP MLD1 can perform a Multi-Link operation alone or in cooperation with the second wireless base station AP MLD2.

Here, a case in which the first wireless terminal STA MLD1 receives a beacon frame including the element with the setting value of No. “1” shown in FIG. 16 and FIG. 17 from the first wireless base station AP MLD1 is described.

First, a case in which the first wireless terminal STA MLD1 chooses to perform a Multi-Link operation with the first wireless base station AP MLD1 alone is described.

When the first wireless terminal STA MLD1 receives a beacon frame including an element with the setting value of No. “1”, it chooses a wireless link in which the Type field is set to a value “0” indicating that it is a Basic Type, and the Subelement ID field is set to a value “3” indicating that it is a Basic variant Multi-Link element. Here, for example, it is chosen to connect the first station STA1-1 to the first access point AP1-1 included in the first wireless base station AP MLD1, and the second station STA1-2 to the second access point AP1-2 included in the first wireless base station AP MLD1.

In the case of connecting to the first access point AP1-1, the frequency channel to be used for wireless communication is set to the frequency channel used when the first station STA1-1 receives a beacon frame from the first access point AP1-1. In other words, it is assumed here that the first station STA1-1 is already set to a frequency channel that allows communications with the first access point AP1-1. On the other hand, in the case of connecting to the second access point AP1-2, a channel number is extracted from the Channel Number field corresponding to the identifier “1” set in the Link ID field of the Reduced Neighbor Report element, and the frequency channel is set to the frequency channel numbered “36”. This channel number is for attempting to connect to the second access point AP1-2 by setting a center frequency with respect to (the wireless unit of) the second station STA1-2 to 5.18 GHz. Note that, as the UMAC layer unit, the MAC address of the first wireless base station AP MLD1 set in the MLD MAC Address field in the Multi-Link element the setting value of No. “1” shown in FIG. 16 is selected.

Now, a case in which the first wireless terminal STA MLD1 chooses to perform a Multi-AP Multi-Link operation for establishing wireless connections with both the first wireless base station AP MLD1 and the second wireless base station AP MLD2 will be described.

When the first wireless terminal STA MLD1 receives a beacon frame including an element with the setting value of No. “1”, first, as one of the wireless links, it chooses a wireless link in which the Type field is set to a value “0” indicating that it is a Basic Type, and the Subelement ID field is set to a value “3” indicating that it is a Basic variant Multi-Link element. Here, for example, it is chosen to connect the first station STA1-1 to the first access point AP1-1 included in the first wireless base station AP MLD1.

Subsequently, the first wireless terminal STA MLD1 chooses, as another wireless link, a wireless link in which the Subelement ID field is set to a value “4” indicating that it is a Multi-AP variant Multi-Link element. Here, for example, it is chosen to connect the second station STA1-2 to the second access point AP2-2 included in the second wireless base station AP MLD2.

As mentioned above, in the case of connecting to the first access point AP1-1, the frequency channel to be used for wireless communication is set to the frequency channel used when the first station STA1-1 receives a beacon frame from the first access point AP1-1. On the other hand, in the case of connecting to the second access point AP2-2, a channel number is extracted from the Channel Number field corresponding to the identifier “3” set in the Link ID field of the Reduced Neighbor Report element, and the frequency channel is set to the frequency channel numbered “44”. This channel number is for attempting to connect to the second access point AP2-2 by setting the center frequency with respect to (the wireless unit of) the second station STA1-2 to 5.22 GHz. Note that, as the UMAC layer unit, the MAC address of the multi-AP controller 21 set in the MLD ID field in the Reduced Neighbor Report element with the setting value of No. “1” shown in FIG. 17 is selected.

In the setting value of No. “2” shown in FIG. 16 and FIG. 17, the Type field is set to a value “4” indicating that it is a MAP Type, and the Subelement ID field is also set to a value “4” indicating that it is a Multi-AP variant Multi-Link element. In other words, the setting value of No. “2” corresponds to a setting example of a case in which a Multi-AP Multi-Link operation can be performed over the first and second wireless base stations AP MLD1 and AP MLD2. In this setting example, the multi-AP controller 21 is selected as the UMAC layer unit, regardless of which access point in the first and second wireless base stations AP MLD1 and AP MLD2 is selected.

In the case of the setting example of No. “2”, the first wireless terminal STA MLD1 cannot recognize solely from the various ID information whether or not the first access point AP1-1 and the second access point AP1-2 included the first wireless base station AP MLD1, or the first access point AP2-1 and the second access point AP2-2 included in the second wireless base station AP MLD2 are implemented in the same chassis.

In contrast, in the setting example of No. “3” shown in FIG. 16 and FIG. 17, it can be distinguished whether or not the first access point AP1-1 and the second access point AP1-2 included in the first wireless base station AP MLD1, or the first access point AP2-1 and the second access point AP2-2 included in the second wireless base station AP MLD2 are implemented in the same chassis.

Specifically, if the access points are in the same wireless base station AP MLD, the setting values of the MLD ID field in the Reduced Neighbor Report element are set to the same value. In addition, the wireless base station AP MLD of which the value of the MLD ID field is “0” is indicated to be the same wireless base station AP MLD (i.e., the first wireless base station AP MLD1) as that of the access point (here, the first access point AP1-1) first set in the Link Info field in the Multi-Link element. The MLD ID fields of the first access point AP2-1 and the second access point AP2-2 included in the second wireless base station AP MLD2 are both set to “1”. Accordingly, in a case where the first wireless terminal STA MLD1 desires to connect to an access point AP included in a different wireless base station AP MLD, the MLD ID field can be referred to in order to select an access point AP in a different wireless base station AP MLD.

### Second Embodiment

Now, a second embodiment will be described. The second embodiment describes an efficient method of resuming communication in a case where communication of one of a plurality of wireless links established between a wireless base station AP MLD and a wireless terminal STA MLD is interrupted. In the present embodiment, a case in which the wireless base station AP MLD performs a Multi-Link operation with the wireless terminal STA MLD using a Block Ack mechanism is assumed.

As described above, in a case where communication is interrupted for a while in one of the multiple wireless links established between the wireless base station AP MLD and the wireless terminal STA MLD while communication is continued in other wireless links, a gap occurs between transmitted data in the wireless link where communication is interrupted and the transmitted data in the wireless link where communication is continued (the wireless link where communication is continued is able to transmit newer data). As a result, when communication is resumed on the wireless link where communication was interrupted, the wireless terminal STA MLD may not be able to reply with an appropriate response frame even though it is able to receive data transmitted through the wireless link. The present embodiment describes a method in which such a situation is detected, and the wireless base station AP MLD transmits a BAR frame to the wireless terminal STA MLD to synchronize a reception history of the wireless terminal STA MLD in each wireless link so that the wireless terminal STA MLD can reply with an appropriate response frame.

As a basic response method, there is a method in which, for the reception of a single data frame, a destination device (receiving station) returns an Ack frame to notify a transmission source device (transmitting station) that it has successfully received the data frame. However, in this method, in a case where a large number of data frames are received, since it is necessary to return an Ack frame for each of the large number of received data frames, the transmission time of a PHY header and the transmission time of the Ack frame in the case of transmitting the data frame become an overhead time. Therefore, the throughput at a MAC layer will be saturated with the PHY rate increase. In order to reduce the transmission time of the PHY header in the case of transmitting the data frames, there is an Aggregated MPDU (A-MPDU) that concatenates multiple data frames into one PHY frame (PSDU: PHY service data unit).

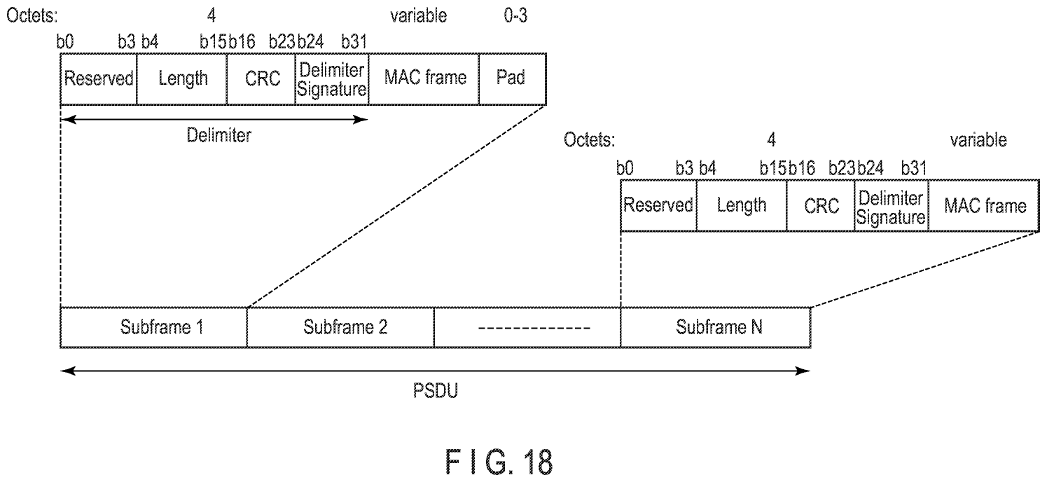

FIG. 18 shows the frame format of an A-MPDU frame. As shown in FIG. 18, the A-MPDU frame is configured by N Subframes (where N is a positive integer) concatenated together. Each Subframe is configured by a Delimiter field, which is boundary information to detect the boundary of the Subframe, and a MAC frame. The Delimiter field has a length of 4 bytes, and includes a Length field that indicates the length of the subsequent MAC frame, a CRC for detecting an error in the Length field, a Delimiter Signature field indicating that the field is a Delimiter field, etc. Since the frame format of the MAC frame following the Delimiter field is the same as the frame format shown in FIG. 2, a detailed explanation of the frame format is omitted here. A Pad field following the MAC frame is a field added to make the Subframe length a multiple of 4 bytes when the Subframe length is not a multiple of 4 bytes, and is added in the range of 1 byte to 3 bytes. A data frame is an MPDU, and a Frame Body field that configures the MPDU includes an MSDU. The MSDU includes UDP packets, TCP packets, etc., that are transferred from an upper layer than the MAC layer.

As shown in FIG. 18, since the A-MPDU frame is a frame in which multiple MAC frames are concatenated, a Block Ack frame is used for a response frame with respect to the reception of the A-MPDU frame, and not an Ack flame. A BA frame can notify delivery confirmation information of multiple data frames by one MAC frame.

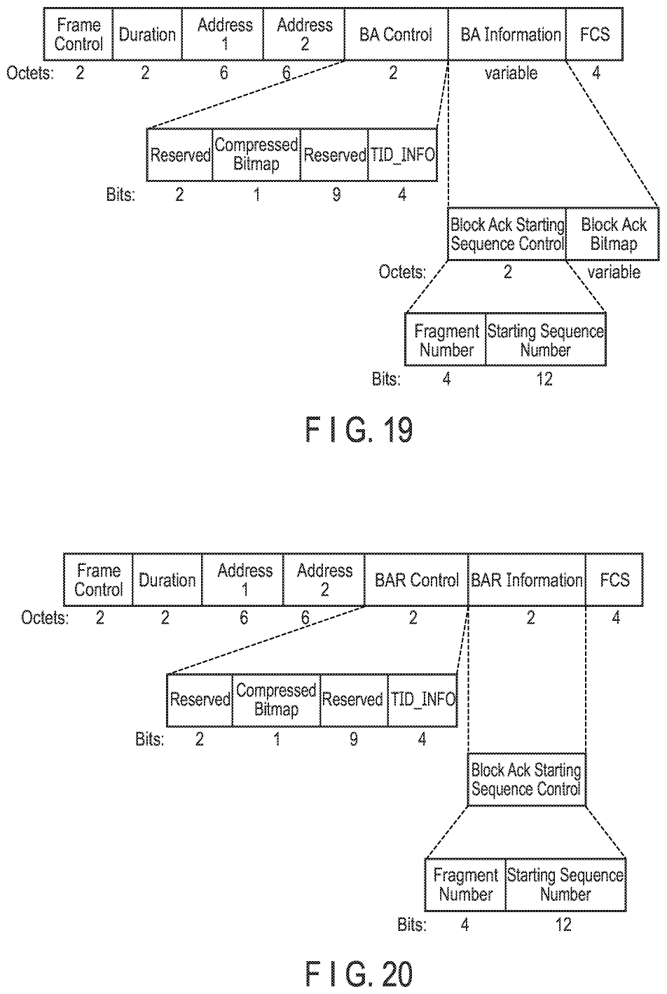

FIG. 19 shows the frame format of the BA frame. The BA frame is configured by a Frame Control field, a Duration field, an Address 1 field, an Address 2 field, a BA Control field, a BA Information field, and an FCS field. The roles of the fields other than the BA Control field and the BA Information field are the same as those of the MAC frame described in FIG. 2. Therefore, detailed explanations thereof are omitted here.

A bit pattern (e.g., Type=2′b01, Subtype=4′b1001, etc.) indicating that it is a BA frame is assigned to a Type field and a Subtype field of the Frame Control field.

The Address 1 field is set with information indicating the destination of the BA frame. For example, in a case where a first station STA1-1 included in a first wireless terminal STA MLD1 transmits a BA frame to a first access point AP1-1 included in a first wireless base station AP MLD1, the MAC address of the first access point AP1-1 is set in the Address 1 field.

The Address 2 field is set with information indicating a transmission source transmitting the BA frame. For example, in a case where the first station STA1-1 included in the first wireless terminal STA MLD1 transmits a BA frame to the first access point AP1-1 included in the first wireless base station AP MLD1, the MAC address of the first station STA1-1 is set in the Address 2 field.

The BA Control field includes at least a Compressed Bitmap field and a TID_INFO field. Note that Reserved fields shown in FIG. 19 indicate unused bits and are set to 0. The unused bits in the Reserved fields can be used for any purpose.

The Compressed Bitmap field is a 1-bit long field and indicates that a field in which the length of the subsequent Block Ack Bitmap field is shortened is used.

The TID_INFO field is a 4-bit long field and indicates a TID of the data frame of subsequent delivery confirmation information (Block Ack Bitmap information). The BA frame includes delivery confirmation information for a data frame having a TID with the same value as the TID set in the TID_INFO field.

As shown in FIG. 19, the BA Information field includes a Block Ack Starting Sequence Control field and a Block Ack Bitmap field. In addition, the Block Ack Starting Sequence Control field includes a Fragment Number field and a Starting Sequence Number (SSN) field.

The Fragment Number field is set with information indicating the field length of the Block Ack Bitmap field and information indicating whether or not the delivery confirmation information of a fragmented data frame is included in the Block Ack Bitmap field.

The SSN field indicates a sequence number of a frame corresponding to the first bit of the subsequent Block Ack Bitmap field.

The Block Ack Bitmap field is a field indicating reception history information of a data frame transmitted by (an access point included in) a wireless base station and received by (a station included in) a wireless terminal (i.e., information indicating whether or not the data frame was successfully received) by a bitmap format which assigns one bit per data frame. A basic length of the Block Ack Bitmap field is 8 bytes. However, depending on the setting value of the Fragment Number field, in addition to 8 bytes, the length of 32 bytes, 64 bytes, or 128 bytes can be selected.

In a case where the delivery confirmation information of the fragmented data frame is not included, the first bit of the Block Ack Bitmap field indicates the delivery confirmation information of the data frame of the sequence number indicated by the SSN field. In the Block Ack Bitmap field, the delivery confirmation information of a frame whose sequence number is increased by one for each bit shift from the top is shown. In other words, the second bit from the top indicates the delivery confirmation information of a data frame with the sequence number indicated by (SSN+1). For example, if the value of the SSN field is 100, the Block Ack Bitmap field includes the delivery confirmation information of the data frame with the sequence number from 100 to 163.

FIG. 20 shows the frame format of the BAR frame. As shown in FIG. 20, the BAR frame configured by a Frame Control field, a Duration field, an Address 1 field, an Address 2 field, a BAR Control field, a BAR Information field, and an FCS field. The BAR is a frame that requests the destination wireless device to reply with a BA frame, and also plays a role in updating BA Window information (WinStart, etc.) held by the wireless device. Note that, since the roles of the fields other than the BAR Control field and the BAR Information field are the same as those in the MAC frame described in FIG. 2, a detailed explanation thereof are omitted here.

In the Type and Subtype fields of the Frame Control field, a bit pattern (e.g., Type=2′b01, Subtype=4′b1000, etc.) is assigned to indicate that the frame is a BAR frame.

The Address 1 field is set with information indicating the destination of the BAP frame. For example, in a case where the first access point AP1-1 included in the first wireless base station AP MLD1 transmits a BAR frame to the first station STA1-1 included in the first wireless terminal STA MLD1, the MAC address of the first station STA1-1 is set in the Address 1 field.

The Address 2 field is set with information indicating the source of transmission of the BAR frame. For example, in a case where the first access point AP1-1 included in the first wireless base station AP MLD1 transmits a BAR frame to the first station STA1-1 included in the first wireless terminal STA MLD1, the MAC address of the first access point AP1-1 is set in the Address 2 field.

The BAR Control field includes at least a Compressed Bitmap field and a TID_INFO field. Note that Reserved fields shown in FIG. 20 indicate unused bits and are set to 0. The unused bits in the Reserved fields can be used for any purpose.

The Compressed Bitmap field is a 1-bit long field and indicates that a BA frame using a field in which the length of the Block Ack Bitmap field is shortened is requested to the destination device (e.g., first station STA1-1).

The TID_INFO field is a 4-bit long field and indicates the TID of the delivery confirmation information (Block Ack Bitmap information) of the BA frame. The first access point AP1-1 requests the first station STA1-1 to transmit a BA frame that includes delivery confirmation information of a TID with the same value as the TID set in the TID_INFO field.

As shown in FIG. 20, the BAR Information field includes a Block Ack Starting Sequence Control field and a Block Ack Bitmap field. In addition, the Block Ack Starting Sequence Control field includes a Fragment Number field and a Starting Sequence Number (SSN) field.

The Fragment Number field is set to 0 and is treated as Reserved in the BAR frame.

The SSN field is set to a sequence number of a frame corresponding to the first bit of the Block Ack Bitmap field of the BA frame requested by the first access point AP1-1.

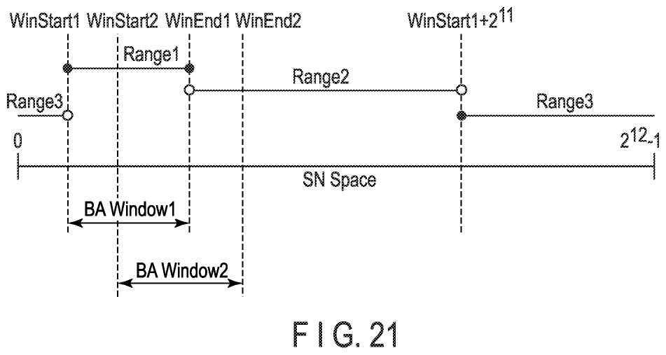

Now, with reference to FIG. 21, a control method of a Block Ack (BA) Window will be explained. The BA Window indicates the range of current delivery confirmation information recorded by a station included in the wireless terminal. In other words, the range of the BA Window corresponds to the range of the delivery confirmation information to be replied by the BP Bitmap field.

The sequence number of the data frame has a length of 12 bits, as already described, and an integer value from 0 to 4095 is assigned to the data frame to be transmitted. On the other hand, the length of the BA Bitmap field is shorter than a sequence number space (SN Space). Here, it is assumed that the length of the BA Bitmap field is 8 bytes (64 bits), which is the basic length. In a case where the length of the BA Bitmap field is 64 bits, the size of the BA Window is also 64 bits. Here, the sequence number space indicates the range of values that the sequence number included in a MAC frame, such as a data frame to be transmitted, can take. In the present embodiment, the sequence number of the data frame is set in the Sequence Control field and has a length of 12 bits. The sequence number can be of a length other than 12 bits. For example, if the sequence number is 13 bits, the range of the sequence number space becomes wider, such as from 0 to 8191. The sequence number may also be set in other fields in the MAC frame or in newly added fields.

In the following, the size of the BA Window is described as WinSize, the one number of the BA Window is described as WinEnd, and the start number of the BA Window is described as WinStart.

As shown in FIG. 21, in a case where a data frame with sequence number SN1 is received at (a station included in) the wireless terminal STA MLD, WinEnd1 becomes sequence number SN1. Also, WinStart1 is calculated by “SN1−(WinSize−1)”. For example, in the case where sequence number SN1 is 163, WinEnd1 is 163, and if WinSize is 64 bits as described above, WinStart1 becomes 100 (=163−(64−1)).

The BA Window is controlled differently depending on which range of Range 1 to Range 3 shown in FIG. 21 sequence number SN2 of the data frame received after the data frame with sequence number SN1 is included in.

First, in the case where sequence number SN2 is included in the range of Range 1 (i.e., WinStart1≤SN2≤WinEnd1), BA Window1 remains unchanged, and the wireless terminal STA MLD sets the bit corresponding to sequence number SN2 to 1, and returns a BA frame, in which the bitmap in the range of BA Window1 is set to the BA Bitmap field, to the wireless base station AP MLD. In this case, the value of the SSN field is set to WinStart1.

Next, in the case where sequence number SN2 is included in the range of Range 2 (i.e., WinEnd1<SN2<WinStart1+2¹¹), the wireless terminal STA MLD sets the bit corresponding to sequence number SN2 to 1, sets the value of WinEnd to sequence number SN2, sets the value of WinStart to a value calculated by “SN2−(WinSize−1)”, and shifts the BA Window. Accordingly, as shown in FIG. 21, the BA Window shifts from BA Window1 to BA Window2. The wireless terminal STA MLD then returns a BA frame, in which the bitmap of the range of BA Window 2 is set to the BA Bitmap field, to the wireless base station AP MLD. In this case, the value of the SSN field is set to WinStart2.

Note that, in a case where the sequence number of the received data frame is included in the range of Range 1 or Range 2, the destination device (wireless terminal) recognizes the data frame as a new frame and recognizes that it is necessary to return a response frame including the delivery confirmation information of the data frame to the transmission source device (wireless base station).

Furthermore, in a case where sequence number SN2 is included in the range of Range 3 (i.e., WinStart1+2¹¹≤SN2<WinStart1), BA Window1 remains unchanged, and the wireless terminal STA MLD recognizes the data frame in which sequence number SN2 is set as an old frame. In this case, the destination device (wireless terminal) returns a BA frame to the transmission source device (wireless base station), in which the BA Bitmap field of the BA frame is set to the bitmap in the range of BA Window1, and the SSN field is set to WinStart1.

Note that, in a case where the sequence number of the received data frame is included in the range of Range 3, the destination device (wireless terminal) recognizes that the data frame is an old frame and, recognizing that it is unnecessary to return a response frame including the delivery confirmation information of the data frame, returns a response frame that does not include the delivery confirmation information. In the present embodiment, the boundary between Range 2 and Range 3 is set to WinStart1+2¹¹; however, may be set to any other value. For example, in the case of widening the range of Range 2, the boundary may be set to WinStart1+3000.

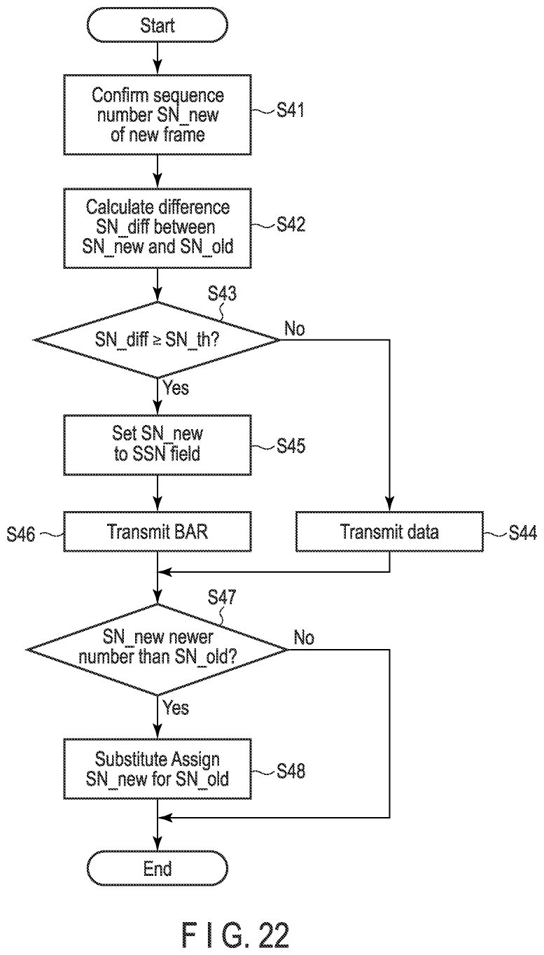

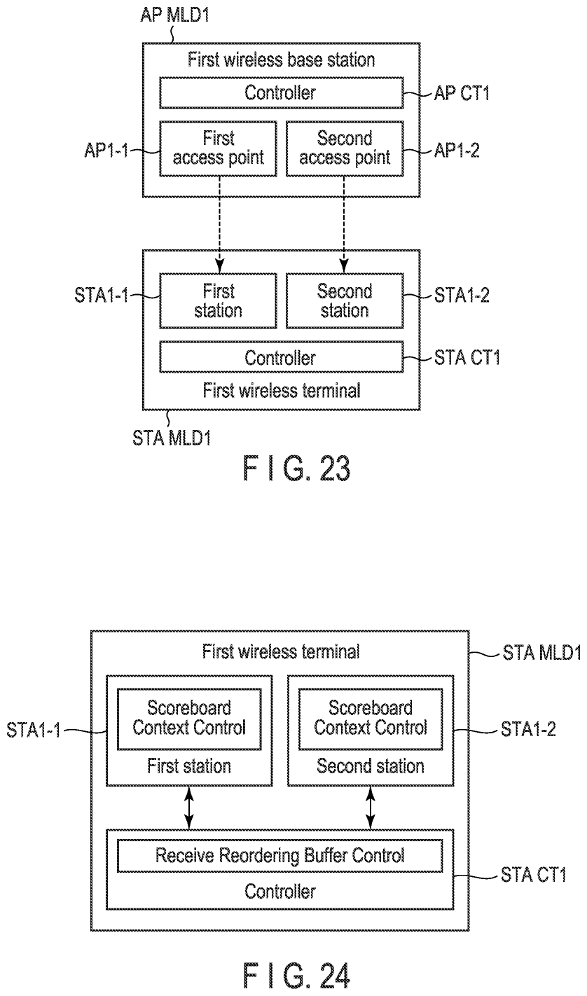

Now, with reference to FIG. 22, a processing procedure for updating the reception history of the wireless terminal STA MLD will be explained. Note that, here, as shown in FIG. 23, the first access point AP1-1 included in the first wireless base station AP MLD1 is wirelessly connected to the first station STA1-1 included in the first wireless terminal STA MLD1, and the second access point AP1-2 included in the first wireless base station AP MLD1 is wirelessly connected to the second station STA1-2 included in the first wireless terminal STA MLD1 (that is, the first wireless base station AP MLD1 performs the Multi-Link operation alone). In this situation, a case is assumed in which the wireless link between the first access point AP1-1 and the first station STA1-1 is interrupted for a while, while communication on the wireless link between the second access point AP1-2 and the second station STA1-2 remains active, or a case in which communication is performed on the wireless link between the second access point AP1-2 and the second station STA1-2 since the communication performed on the wireless link between the second access point AP1-2 and the second station STA1-2 is in a better communication environment (e.g., the communication speed is faster, there is less communication traffic by other wireless devices, etc.) than the communication performed on the wireless link between the first access point AP1-1 and the first station STA1-1.

First, tho first access point AP1-1 included in the first wireless base station AP MLD1 confirms the sequence number (hereinafter referred to as SN_new) of a new data frame that is transferred from the controller AP CT1 (step S41).

Then, based on the latest sequence number of the data frame among the sequence numbers of the data frames that were successfully transmitted to the first station STA1-1 immediately before the wireless link was interrupted (hereinafter referred to as SN_old) and SN_new mentioned above, the first access point AP1-1 calculates the difference between these two sequence numbers (hereinafter referred to as SN_diff) (step S42). In the processing in step S42, the method of calculating SN_diff differs between a case in which SN_new is greater than or equal to SN_old and a case in which SN_new is smaller than SN_old.

Specifically, in the case where SN_new is greater than or equal to SN_old, SN_diff is calculated by “SN_new−SN_old”. On the other hand, in the case where SN_new is smaller than SN_old, SN_diff is calculated by “4095−SN_old+SN_new”.

After the processing in step S42, the first access point AP1-1 determines whether or not the SN_diff calculated by the processing in step S42 is equal to or greater than a predetermined threshold value (hereinafter referred to as SN_th) (step S43). SN_th is set to 1900, for example, but may be set to any other value. However, if SN_th is too small, the transmission frequency of the BAR frame becomes high, and on the other hand, if SN_th is too large, the BAR frame may not be transmitted ever if it is necessary. Therefore, it is desirable to set SN_th to a value that is larger than WinSize and smaller than approximately half of the sequence number space (i.e., WinSize<SN_th≤SN Space/2).

Before starting a BA mechanism with the first station STA1-1 included in the first wireless terminal STA MLD1, the first access point AP1-1 performs a negotiation sequence in which the specified frames are exchanged. Through this negotiation sequence, the first access point AP1-1 is able to grasp WinSize, which is the size of BA Window supported by the first station STA1-1, and able to set SN_th as described above.

As a result of the processing in step S43, in the case where it is determined that SN_diff is smaller than SN_th (No in step S43), the first access point AP1-1 transmits the new data frame transferred from the controller AP CT1 to the first station STA1-1 (step S44) and proceeds with the processing in step S47 described below.

On the other hand, as a result of the processing in step S43, in the case where it is determined that SN_diff is greater than or equal to SN_th (Yes in step S43), the first access point AP1-1 sets SN_new to the SSN field of the BAR frame (step S45). Note that, in a case where there are multiple new data frames scheduled to be transmitted to the first station STA1-1, the smallest value among the sequence numbers of these multiple data frames is selected as SN_new. For example, in the case where the sequence numbers of the data frames to be transmitted are 1000 to 1005, 1000 is selected as the SN_new. The value set in the SSN field does not necessarily have to be SN_new. It may be any value that requires the first station STA1-1 to include the delivery confirmation information of the data frame in the BA frame when it receives the data frame. However, it is preferable to avoid setting a value larger than SN_new, although it is acceptable to set a value somewhat smaller than SN_new (e.g., only WinSize being a small value).

After the processing in step S45, the first access point AP1-1 transmits a BAR frame in which SN_new is set in the SSN field to the first station STA1-1 (step S46).

Next, the first access point AP1-1 determines whether or not SN_new is a newer number than SN_old (step S47). As a result of the processing in step S47, in the case where it is determined that SN_new is not a newer number than SN_old, that is, it is an older number (No in step S47), the first access point AP1-1 ends the series of processing here.

On the other hand, as a result of the processing in step S47, in the case where it is determined that SN_new is a newer number than SN_old (Yes in step S47), the first access point AP1-1 assigns SN_new to SN_old (i.e., SN_old is updated to SN_new) (step S48), and ends the series of processing here.

When the first station STA1-1 in the first wireless terminal STA MLD1 receives the BAR frame transmitted from the first access point AP1-1, it updates WinStart, which is the start number of the BA Window, to the sequence number (i.e., SN_new) set in the SSN field in the BAR frame. This means that the range of the BA Window maintained by the first station STA1-1 can be updated according to the sequence number set in the SSN field in the BAR frame. Therefore, in the case where the first station STA1-1 receives a new data frame transmitted from the first access point AP1-1 thereafter, it can return a BA frame including appropriate delivery confirmation information to the first access point AP1-1.

According to the second embodiment described above, in the case where communication of one of the multiple wireless links established between the wireless base station AP MLD and the wireless terminal STA MLD is interrupted for a while (here, this includes not only a state in which communication is not possible at all, but also a case in which it takes a long time to start transmitting frames due to a busy state, or a case in which the probability of receiving a response frame is lower than expected value even if the frame is transmitted, etc.) while communications of the other wireless links are continued, and the wireless link whose communication was interrupted has been restored subsequently (here, this includes a case in which the above-mentioned busy state changes to an idle state, or a case in which the probability of receiving a response frame to the transmitted frame is higher than the expected value, etc.), the access point corresponding to the restored wireless link compares the sequence number SN_new of the new data frame and the sequence number SN_old of the data frame that was successfully transmitted immediately before the communication was interrupted, and, in the case where the difference SN_diff is greater than or equal to the threshold value SN_th, transmits the BAR frame to update the range of the BA Window held by the corresponding station. Therefore, in the case of receiving a new data frame transmitted thereafter from the corresponding access point, the corresponding station can return a BA frame including appropriate delivery confirmation information to the access point, and can efficiently resume transmission of the new data frame.

In the following, a modified example of the second embodiment is described.

### First Modified Example of Second Embodiment

Every time the first station STA1-1 receives a new data frame from the first access point AP1-1, the first station STA1-1 may reset the frame reception history information in the MAC layer unit up to immediately before receiving the data frame or before determining whether the data frame has been successfully received to 0. Specifically, when a PHY layer unit transfers a PSDU frame including a data frame to the MAC layer unit, in a case where the MAC layer unit has received (accepted) a reception request notification from the PHY layer unit, the MAC layer unit resets the frame reception history information it holds up to immediately before receiving the PSDU frame to 0, then updates the reception status of the PSDU frame. Note that, resetting the frame reception history information to 0 means to set the MAC layer unit to a state where no history information is held (no temporary record), or to set the MAC layer unit to a state immediately after establishing the BA mechanism. The frame reception history information may be reset in a case where the data frame is received, and may not be reset in a case where the BAR frame is received.

Furthermore, in the case where the data frame the first station STA1-1 receives from the first access point AP1-1 is a new data frame, and the data frame with a sequence number whose difference from the sequence number set in the SSN field of the bitmap held by the first station STA1-1 is greater than or equal to the above-mentioned SN_th is received X times (where X is an integer greater than or equal to 0), the MAC layer unit may reset the frame reception history information it holds to 0 (e.g., in the state immediately after establishing the BA mechanism).

In addition, in the case where the difference between the sequence number of the new data frame transmitted from access point AP1-1 and the sequence number set in the SSN field of the bitmap held by the first station STA1-1 is greater than or equal to the above-mentioned SN_th, she first station STA1-1 inquires the other wireless link (e.g., a second station STA1-2) included in the first wireless terminal STA MLD1 about its reception history status, and confirms the sequence number set in the SSN field of the bitmap held by the second station STA1-2. In the case where the difference between the sequence number set in the SSN field of the bitmap held by the first station STA1-1 and the sequence number set in the SSN field of the bitmap held by the second station STA1-2 is grater than or equal to the above-mentioned SN_th, the first station STA1-1 updates the WinStart of the BA Window of the first station STA1-1 to the WinStart of the second station STA1-2.

### Second Modified Example of Second Embodiment

The first access point AP1-1 may transmit a BAR frame when any of the following conditions is met.

(Condition 1)

The first access point AP1-1 compares the sequence number of the data frame to be transmitted that is stored in the transmission buffer implemented in the first access point AP1-1 (hereinafter referred to as SN_new1) and the latest sequence number among the sequence numbers of the data frame of the most recent successful transmission to the first station STA1-1 (hereinafter referred to as SN_old1). In the case were the difference between these sequence numbers exceeds the size of the BA Window held by the first station STA1-1, the first access point AP1-1 transmits a BAR frame in which SN_new1 is set in the SSN field to the first station STA1-1.

(Condition 2)

The first access point A21-1 holds a BA Window update timer. In the case where the first access point AP1-1 successfully transmits a data frame or a BAR frame to the first station STA1-1 (that is, in the case where the intended BA frame is received), the first access point AP1-1 sets the value of the BA Window update timer to, for example, Y [sec] (e.g., four seconds) and starts counting down in usec units. In the case where, the data frame or the BAR frame is successfully transmitted to the first station STAT1-1 in the middle of the countdown, the value of the BA Window update timer is set to Y [sec] again.

On the other hand, when the value of the BA Window update timer becomes 0, the first access point AP1-1 transmits to the first station STA1-1 a BAR frame in which the sequence number of the data frame that was failed to be transmitted to the first station STA1-1 is set in the SSN field.

(Condition 3)

In the case of attempting to transmit a new data frame to the first station STA1-1 after Y [sec] or more from the point at which the first access point AP1-1 has most recently transmitted a data frame or a BAR frame successfully to the first station STA1-1, the first access point AP1-1 transmits to the first station STA1-1 a BAR frame in which the sequence number of the new data frame to be transmitted is set in the SSN field before the new data frame is transmitted.

(Condition 4)

In the case where a new data frame is transmitted to the first station STA1-1 after Y [sec] or more from the point at which the first access point AP1-1 has most recently transmitted a data frame or a BAR frame successfully to the first station STAT1-1, and the number of retransmissions of the new data frame is M times or more, the access point AP1-1 transmits to the first station STA1-1 a BAR frame in which the sequence number of the new data frame set the SSN field.

(Condition 5)

In the case where the first access point AP1-1 transmits a data frame with a sequence number (hereinafter referred to as SN_new5) to the first station STA1-1 and receives a BA frame returned by the first station STA1-1, first access point AP1-1 calculates the difference between the sequence number set in the SSN field in the received BA frame (hereinafter referred to as SN_ba) and the above SN_new5 (hereinafter referred to as SN_diff5). Note that the method of calculating SN_diff5 is different between a case in which SN_new5 is greater than or equal to SN_ba and a case in which SN_new5 is smaller than SN_ba.

Specifically, in the case where SN_new5 is greater than or equal to SN_ba, SN_diff5 is calculated by “SN_new5−SN_ba”. On the other hand, in the case where SN_new5 is smaller than SN_ba, SN_diff5 is calculated by “4095−SN_ba+SN_new5”. In the case where SN_diff5 is greater than or to SN_th mentioned above, the first access point AP1-1 transmits a BAR frame in which SN_new5 is set in the SSN field to the first station STA1-1. Here, the frame is a BAR frame; however, it can be any other frame. For example, an Action frame including at least a TID field and an SSN field may be transmitted.

### Third Embodiment

A third embodiment will further be described. In the second embodiment described above, the processing in which (the access point included in) the wireless base station AP MLD transmits a BAR frame to update the reception history of the wireless terminal STA MLD side is mainly described. However, in the present embodiment, processing in which the wireless terminal STA MLD autonomously updates the reception history is described.

FIG. 24 is a block diagram showing an example of a schematic configuration of a first wireless terminal STA MLD1 according to the embodiment. As described above, the first wireless terminal STA MLD1 includes a first station STA1-1, a second station STA1-2, and a controller STA CT1. The first station STA1-1 and the second station STA1-2 correspond to wireless link units 310 and 320 of the wireless communication device 300, and the controller STA CT1 corresponds to a control unit 330 of the wireless communication device 300.

A scoreboard context control (hereinafter referred to as SCC) included in the first station STA1-1 and a scoreboard context control included in the second station STA1-2 are both functional units included in an LMAC layer unit. A receive reordering buffer control (hereinafter referred to as RxRBC) included in the controller STA CT1 is a functional unit included in a UMAC layer unit.

The SCC stores delivery confirmation information including the reception status (e.g., that an MPDU was successfully received) of a MAC frame (e.g., MPDU) received from a transmission source device (e.g., access point AP1-1) by a destination device (e.g., station STA1-1). The SCC also stores a transmission source MAC address, TID, and sequence number of the frame when successful reception is confirmed.

The delivery conformation information records successful reception in a bitmap format. The delivery confirmation information has a plurality of bit fields that use one bit per MPDU frame. It indicates that the MPDU frame corresponding to a bit field for which 1 stands has been successfully received. The length of the bit map is 64 bits, for example, and by returning a BA frame including the bit map by the first station STA1-1, the delivery confirmation information can be notified to the first access point AP1-1 in the first wireless base station AP MLD1. The BA frame is provided with a field to set a start sequence number (hereinafter referred to as “SSN”), which is indicated by the first bit in the bitmap. The sequence number increases by one from the start sequence number every time it is shifted by one bit from the first bit of the bitmap. In other words, the first bit of the bitmap is the delivery confirmation information of the MPDU frame with the sequence number indicated by SSN, and the next bit is the delivery confirmation information of the data frame with the sequence number indicated by SSN+1.

At least one piece of bitmap information is held for each pair of transmission source MAC address and TID. There are two methods for holding bitmap information, such as Partial-State Operation and Full-State Operation. In Partial-State Operation, in a case where all pieces of bitmap information held by the SCC are used and, in a state where there is no other memory area to store the bitmap information, an MPDU frame including a new transmission source MAC address or TID is received, any piece of bitmap information among one or more recorded pieces of bitmap information is reset to 0, and reception information of the newly received MPDU frame is recorded. On the other hand, in the Full-State Operation, the bitmap information corresponding to a full-state is used exclusively for one transmission source MAC address and TID. Therefore, even in a case where an MPDU frame including a new transmission source MAC address or TID is received, its bitmap information is not reset. In the present embodiment, both holding methods can be applied.

The RxRBC temporarily stores the received frames transferred from the first and second stations STA1-1 and STA1-2 in its memory. When the RxRBC stores the received frame in the memory (or after storing the received frame in memory), it performs reordering processing to reorder the MAC frames according to the order of sequence numbers for each pair of transmission source MAC address and TID included in the MAC Header. The purpose is to reorder the received frames in the sequence number order in the case where the RxRBC transfers the received frames to the next processing in the MAC layer of the wireless communication system (e.g., replay detection processing, which is one of the authentication processing) or outside the MAC layer.

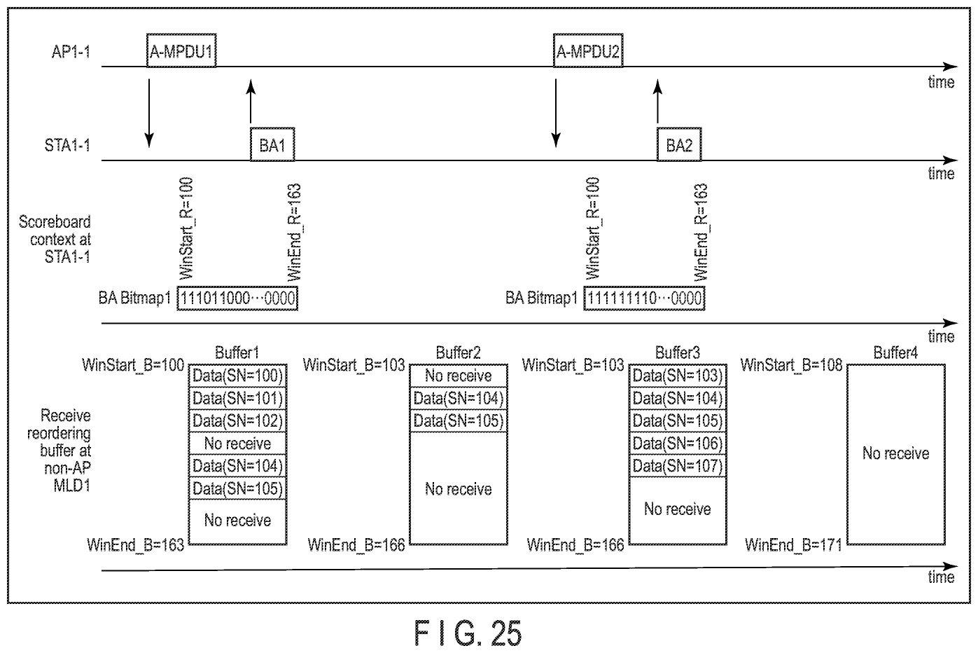

FIG. 25 describes controls performed by the SCC and the RxRBC.

A-MPDU1 shown in FIG. 25 includes QoS data frames (one of the MPDU frames) with sequence numbers from 100 to 105. A-MPDU2 includes QoS data frames with sequence numbers 103, 106, and 107.

In FIG. 25, a case in which the first access point AP1-1 transmits A-MPDU1 to the first station STA1-1, and QoS data frames with sequence numbers other than 103 are received by the first station STA1-1 is assumed. In this case, when assuming that the state of BA Bitmap1 immediately before receiving A-MPDU1 (in other words, the start and end numbers of the BA Window) is “WinStart_R=100” and “WinEnd_R=163”, where WinSize_R, which is the size of BA Bitmap1 (in other words, the size of the BA Window), is 64, and all bits are 0, in the bitmap in BA Bitmap1 after receiving A-MPDU1, the bit positions of sequence numbers 100, 101, 102, 104, and 105 of the frames received by the SCC included in the first station STA1-1 are set to 1, and the other bits remain 0. Since the frames with sequence numbers 100, 101, 102, 104, and 105 are transferred from the SCC to the RxRBC, the data as shown in Buffer1 is stored in a receive buffer of the RxRBC. The RxRBC then transfers the frames with sequence numbers 100 to 102, which are consecutive from the smallest sequence number among the received frames, to the next processing in the MAC layer. Therefore, the receive buffer of the RxRBC becomes the state of Buffer2, WinStart_B becomes 103, and WinEnd_B becomes 166.

Next, a case in which the first access point AP1-1 transmits A-MPDU2 to the first station STA1-1, and all QoS data frames are received by the first station STA1-1 is assumed. In this case, the bit positions of the sequence numbers 103, 106, and 107 of the frames received by the SCC included in the first station STA1-1 are set to 1 in the bitmap in the BA Bitmap2 after the reception of A-MPDU2. As a result, the bit positions of the sequence numbers 100 through 107 are set to 1, and the rest are set to 0. At this time, since the frames of sequence numbers 103, 106, and 107 are transferred from the SOC to the RxRBC, the data as shown in Buffer3 is stored in the receive buffer of the RxRBC. Subsequently, as in the case described above, the RxRBC transfers the frames with sequence numbers 103 to 107, which are consecutive from the smallest sequence number among the received frames, to the next processing in the MAC layer. Therefore, the receive buffer of the RxRBC becomes empty as shown in Buffer4, WinStart_B becomes 108, and WinEnd_B becomes 171.

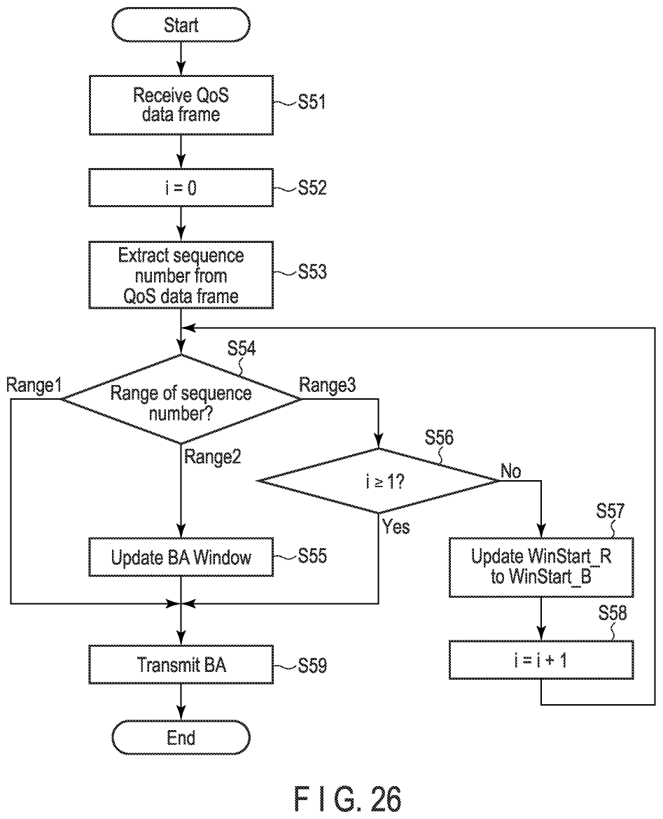

FIG. 26 is a flowchart showing the processing procedure for updating the BA Window executed by the SCC.

First, the SCC receives the QoS data frame transmitted from the wireless base station AP MLD (step S51). Next, the SCC resets a parameter i, which will be described later, to 0 (step S52). The SCC extracts the sequence number from the Sequence Control field of the QoS data frame received in the processing in step S51 (step S53).

The SCC confirms whether or not the sequence number extracted by the processing in step S53 is included in any of the ranges from Range 1 to Range 3 shown in FIG. 21 (step S54).

As a result of the processing in step S54, in a case where it is determined that the extracted sequence number is included in the range of Range 1 (Range in step S54), the SCC determines that the sequence number is included in the range of the current BA Window and that updating WinStart_R and WinEnd_R is unnecessary, and executes the processing in step S59 described below.

As a result of the processing in step S54, in a case where it is determined that the extracted sequence number is included in the range of Range 2 (Range 2 in step S54), the SCC determines that the sequence number is a newer sequence number than the current WinEnd_R, updates WinEnd_R to the sequence number, and updates WinStart_R to the value calculated by “WinEnd_R−(WinSize−1)” to update the BA Window (step S55). Subsequently, the SCC executes the processing in step S59 described below.

As a result of the processing in step S54, in the case where it is determined that the extracted sequence number is included in the range of Range 3 (Range 3 in step S54), the SCC determines that the sequence number is an older sequence number than the current WinEnd_R, and, subsequently, confirms whether or not the parameter i is greater than or equal to 1 (step S56). The parameter i indicates the number of times the sequence number is determined to be in the range of Range 3 for one QoS data frame reception and the BA Window is updated.

As a result of the processing in step S56, in the case where it is determined that the parameter i is smaller than 1, that is, the BA Window has not been updated for one QoS data frame reception (No in step S56), the SCC updates WinStart_R to WinStart_B notified by the RxRBC. In accordance with the update of WinStart_R, the SCC also updates WinEnd_R to the value calculated by “WinStart_R+(WinSize−1)” (step S57). Subsequently, the SCC updates the value of parameter i to a value incremented by 1 (step S58), and executes the processing in step S54 again.

On the other hand, as a result of the processing in step S56, in the case where it is determined that the parameter i is greater than or equal to 1, that is, the number of times the BA Window has been updated is greater than or equal to 1 (Yes in step S56), the SCC transmits a BA frame including bitmap information in the range indicated by the BA Window to the first access point AP1-1 included in the first wireless base station AP MLD 1 (step S59), and ends the series of processing here. Note that, the parameter i indicates the number of times the WinStart_R held by the SCC is updated to the WinStart_B held by the RxRBC for one QoS data frame reception. In the processing in step S56 of FIG. 26, in the case where WinStart_R has been updated once, the second and subsequent WinStart_R updates are not performed, and the processing proceeds to step S59. This is because it is assumed that the update of WinStart_B does not occur frequently within a short period of time and that the value will not change even if WinStart_R is updated two or more times. On the other hand, if it is assumed that WinStart_B is updated multiple times from the time when the first station STA1-1 receives a QoS data frame to the time when it starts transmitting a BA frame in response thereto, in the processing in step S56, a value of “2” or more may be set as the threshold value instead of “1”.

According to the third embodiment described above, the wireless terminal STA MLD can autonomously update the start number and end number of the BA Window based on the sequence number of the data frame transmitted and received from the wireless base station AP MLD. In other words, the wireless terminal STA MLD can update the BA Window Bitmap information without receiving the BAR frame from the wireless base station AP MLD, and, for example, can efficiently resume communication in a wireless link where communication has been interrupted.

In the following, a modified example of the third embodiment is described.

### First Modified Example of Third Embodiment

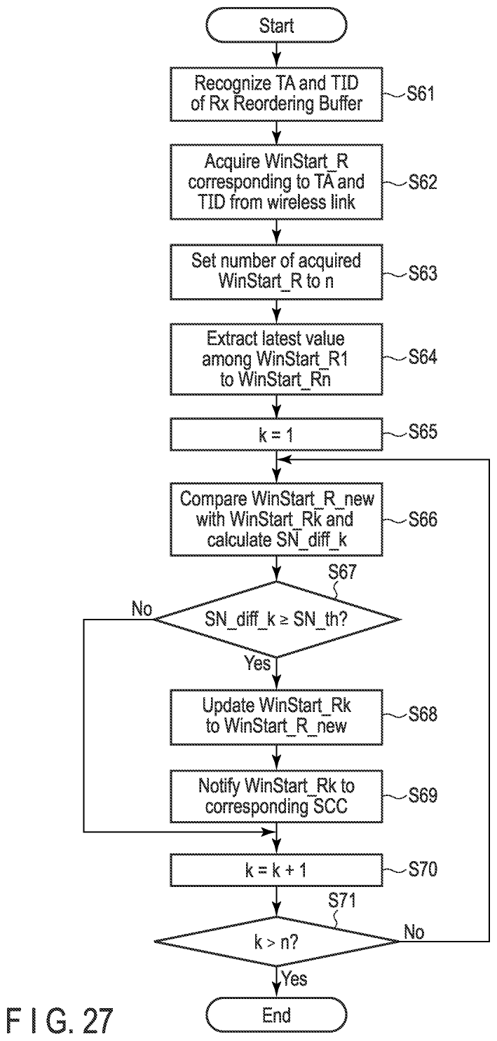

FIG. 27 is a flowchart showing the processing procedure for updating WinStart_R executed by the RxRBC.

First, the RxRBC recognizes the transmission source MAC address (TA) and TID of a receive Reordering Buffer (Rx Reordering Buffer), which is managed for each transmission source MAC address and TID (step S61).

The RxRBC then searches for an SCC that manages a BA Bitmap that matches the transmission source MAC address and TID recognized in the processing in step S61, and, from the SCC unit obtained as a result of the search, the RxRBC obtains WinStart_R and an identifier of the wireless link unit that includes the SCC (that is, the ID of the station STA (e.g., Link ID and MAC address)) (step S62).

The RxRBC sets the number of WinStart_Rs obtained in the processing in step S62 to a parameter n (where n is an integer greater than or equal to 1), which is one of the internal parameters (step S63).

In the following description, a case in which WinStart_Rs obtained in the processing in step S62 are WinStart_R1, WinStart_R2, . . . , WinStart_Rn, and the IDs of the wireless link units corresponding to these WinStart_Rs are ID1, ID2, . . . , IDn is assumed.

The RxRBC extracts the latest value among the obtained WinStart_R1 to WinStart_Rn (step S64). In the following, the extracted latest value will be referred to as WinStart_R_new. For example, if WinStart_R2 is the latest value, WinStart_R_new above becomes WinStart_R2. Note that the WinStart_R of the SSC included in the wireless link unit that recently transferred the received frame to the RxRBC may be extracted as the latest value, or the WinStart_R closest to the WinStart_B held by the RxRBC may be extracted as the latest value.

Next, the RxRBC initializes parameter k, which is one of its internal parameters, to 1 (step S65). The RxRBC compares WinStart_Rk with WinStart_R_new and calculates the difference (hereinafter referred to as SN_diff_k) (step S66). In the processing in step S66, the method of calculating SN_diff_k differs between the case in which WinStart_Rk is greater than or equal to WinStart_R_new and the case in which WinStart_Rk is smaller than WinStart_R_new.

Specifically, in the case where WinStart_Rk is greater than or equal to WinStart_R_new, SN_diff_k is calculated by “(WinStart_Rk)−(WinStart_R_new)”. On the other hand, in the case where WinStart_Rk is smaller than WinStart_R_new, SN_diff_k is calculated by “4095−(WinStart_R_new)+(WinStart_Rk)”.

The RxRBC determines whether or not SN_diff_k calculated in the processing in step S66 is equal to or greater than a predetermined threshold value (hereinafter referred to as SN_th) (step S67). As a result of the processing in step S67, in the case where it is determined that SN_diff_k is smaller than SN_th (No in step S67), the processing in step S70 described below is performed.

On the other hand, as a result of the processing in step S67, in the case where it is determined that SN_diff_k is greater than or equal to SN_th (Yes in step S67), the RxRBC updates WinStart_Rk to WinStart_R_new (step S68).

The RxRBC notifies the SCC of the wireless link unit corresponding to the IDk identifier to set the WinStart_Rk updated in the processing step S68 to WinStart_R (step S69).

The RxRBC then increments the parameter k by 1 (step S70) and determines whether or not the new parameter k calculated in the processing in step S70 is greater than the parameter n (step S71). As a result of the processing in step S71, in the case where it is determined that the parameter k is smaller than or equal to the parameter n (No in step S71), the processing in step S66 is executed again for the new parameter k.

On the other hand, as a result of the processing in step S71, in the case where it is determined that the parameter k is greater than the parameter n (Yes in step S71), the RxRBC determines that it has processed all the WinStart_Rs obtained in the processing in step S62, and ends the series of processing here.

Note that the timing at which the RxRBC obtains the WinStart_R of each SSC in the processing in step S62 described above is specified by an update timer (not shown) provided in the wireless terminal STA MLD. For example, this timing may be specified at each target beacon transmission time (TBTT) or at each multiple of a beacon interval. The timing at which the RxRBC obtains the WinStart_R of each SSC may be at each timing when a beacon frame is transmitted or received. The timing at which the RxRBC obtains the WinStart_R of each SSC may be at each timing at which the RxRBC transfers a certain number of frames (e.g., 128 frames) stored in the receive buffer to the next processing unit.

Furthermore, as shown in step S69 above, it is preferable that the timing at which the WinStart_R of the SCC included in the corresponding wireless link unit is updated is at least after the WinStart_R of each SCC is obtained by the RxRBC and the WinStart_R_new is updated. The timing at which the SCC that receives the WinStart_R notification from the RxRBC actually updates the value may be immediately after the notification, or after transmitting some kind of MAC frame, or immediately after the PHY layer unit issues a receive request signal to the LMAC layer unit requesting to receive some kind of demodulated frame. However, it is preferable to avoid the period when the LMAC layer unit is analyzing the received frame as the update timing.

In addition, in the above processing in step S64, the RxRBC extracts the latest value among the obtained WinStart_R1 to WinStart_Rn; however, the value extracted by the RxRBC does not have to be the latest value. For example, the first access point AP1-1 included in the first wireless base station AP MLD1 may transmit a MAC frame with a sequence number that matches “(WinStart_R)−1” (indicating a value that is smaller than the value of WinStart_R by one) that was transmitted through another wireless link to the wireless link unit which is updated to the latest WinStart_R. In this case, the SCC in the wireless link unit may recognize the sequence number as an old number. Therefore, the value extracted by the RxRBC is not limited to the latest value. Another way for the RxRBC to extract (select) one WinStart_R may be, for example, to randomly select WinStart_R from among the WinStart_Rs held by SCCs that have transferred frames within 200 ms (i.e., select from among SCCs that have recently updated their WinStart_Rs and avoid selecting WinStart_Rs of SCCs that have not been updated for some time). Alternatively, the RxRBC may randomly select WinStart_R from among WinStart_Rs that fall within the range of ±WinSize_R of WinStart_B.

In the processing in steps S68 and S69 above, the RxRBC updates WinStart_R of the SCC of the wireless link unit that needs to be updated. However, for example, instead of updating WinStart_R of the SCC of the corresponding wireless link unit, the RxRBC may reset WinStart_R of the SCC of the corresponding wireless link unit to an initial state. Specifically, the RxRBC may reset the BA Bitmap information including the transmission source MAC address and TID for which an initialization request was made to 0 and reset the BA Bitmap to a state where no delivery confirmation information is recorded (to a no temporary record state), or to a state at the time of ADDBA (at the time of negotiation where ADDBA Request and ADDBA Response frames are exchanged before starting the BA mechanism).

The RxRBC obtains WinStart_R of each SCC. However, it is not limited to WinStart_R, and the RxRBC may obtain other values as long as the information indicates the range of the delivery confirmation information stored in the SCC. For example, the RxRBC may obtain WinEnd_R of each SCC and update WinEnd_R of the corresponding SCC.

The update and reset processing of WinStart_R by the SCC described above is necessary in the case where wireless communication is performed by multiple links. On the other hand, in a conventional wireless communication with a single link, the above-mentioned update and reset processing of WinStart_R may also be performed by the SSC but is not necessarily required. Therefore, in the case where the wireless terminal STA MLD performs wireless communication with the wireless base station AP MLD by multiple links, the SSC performs update and reset processing of WinStart_R, and, in the case where the wireless terminal STA MLD performs wireless communication with (the access point included in) the wireless base station that does not support multi-link communication, the SSC may be controlled not to perform the update or reset processing of WinStart_R.

In the above, a case in which the wireless terminal STA MLD transmits the BA frame is assumed; however, the same can be applied to a case in which the wireless base station AP MLD returns the BA frame to the QoS data frame from the wireless terminal STA MLD.

### Second Modified Example of Third Embodiment

In the following, a method in which the first access point AP1-1 included in the first wireless base station AP MLD1 transmits a frame to the first station STA1-1 included in the first wireless terminal STA MLD1, and the SCC of the first station STA1-1 is initialized is described. Note that, in the present modified example, the frame transmitted to initialize the SCC of the first station STA1-1 may be transmitted in the case where Conditions 1 to 5 shown in the second embodiment above are met.

One example of a method of initializing the SCC of the first station STA1-1 is to use, for example, an Action frame.

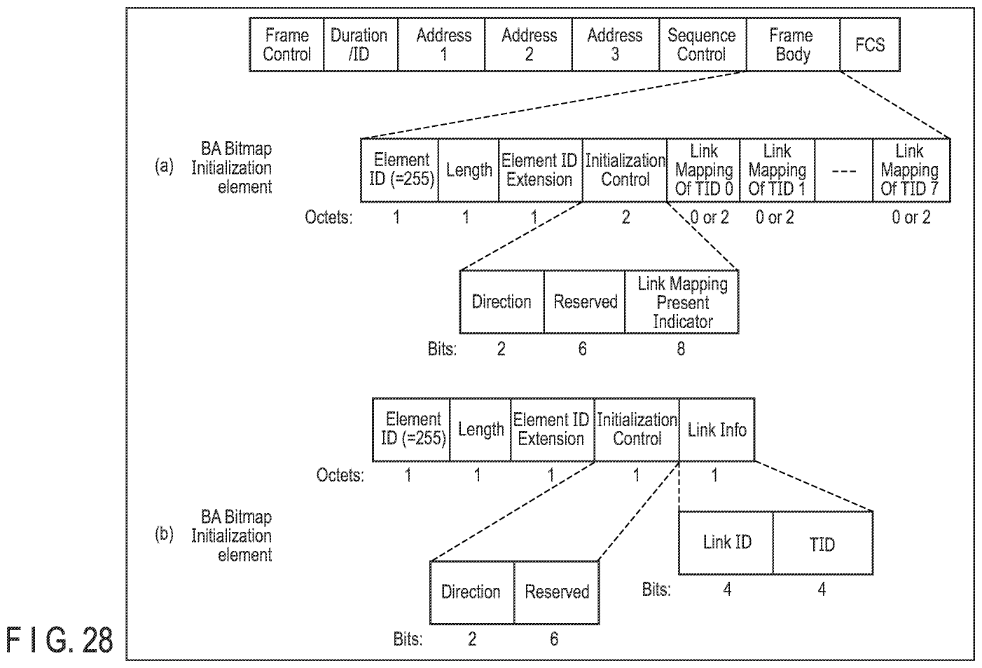

FIG. 28 shows a frame format of an Action frame. The Action frame enables a transmission source device to notify, instruct, request, or report, etc., to a destination device by including various information fields in a Frame Body field. Here, a case in which the Action frame is used to request the initialization of a BA Bitmap is explained.

A BA Bitmap Initialization element is included in the Frame Body field to request the initialization of the BA Bitmap. In the following, two types of BA Bitmap Initialization elements are described.

In the format shown in FIG. 28(a), the BA Bitmap Initialization element includes an Element ID field, a Length field, an Element ID Extension field, an Initialization Control field, and Link Mapping Of TID n (where n is one of the values from 0 to 7) fields.

The Element ID field is set to “255”, and the Element ID Extension is placed immediately after the Length field.

The Length field indicates the length of the field from the Element ID Extension to the Link Mapping Of TID n field in octets. For example, in the case where all fields from Link Mapping Of TID 0 to Link Mapping Of TID 7 are included, the length is 16 octets. Furthermore, by adding the length of the Element ID Extension field and the Initialization Control field thereto, the Length field is set to “19”.

In the Element ID Extension field, a value indicating a “BA Bitmap Initialization element” is set, which is, for example, “150”.

The Initialization Control field has a length of 2 octets and is configured by 2 bits of a Direction bit, 6 bits of a Reserved bit, and 8 bits of a Link Mapping Present Indicator bit.

The Direction bit indicates the direction of frame transmission, where 0 means an uplink direction (i.e., the direction in which the wireless terminal STA MLD transmits frames to the wireless base station AP MLD) and 1 means a downlink direction (i.e., the direction in which the wireless base station AP MLD transmits frames to the wireless terminal STA MLD). Note that, 2 indicates bidirectional, which means that frames are transmitted in both uplink and downlink directions.

The Reserved bit is an unused bit and is basically set to 0.

The Link Mapping Present Indicator bit is a bit for indicating whether or not a Link Mapping Of TID n field is present thereafter. If 1 is set at bit position n of the Link Mapping Present Indicator bit, it means that the Link Mapping Of TID n field is present. If 0 is set at but position n, it means that the Link Mapping Of TID n field is not present. For example, in the case where the Link Mapping Present Indicator bit is set to “8′b1000_0011”, it means that the Link Mapping Of TID 0, Link Mapping Of TID 1, and Link Mapping Of TID 7 where 1 stands are present, and Link Mapping Of TID 2 to Link Mapping Of TID 6 remaining in a 0 state are not present.

The Link Mapping Of TID n field indicates a wireless link by which the MAC frame of TID n is allowed to be transmitted. In the case where 1 is set at bit position i of the Link Mapping Of TID n field, it indicated that the frame of TID n is transmitted by Link ID i is wirelessly connected. For example, in a case where the Link Mapping Of TID 0 field is set to “16′h0000_0001” and the Direction bit is set to 1, it means that a frame in which the TID is “0” is transmitted from the first access point AP1-1 included in the first wireless base station MLD1 to the first station STA1-1 included in the first wireless terminal STA MLD1 using a wireless link unit in which the Link ID is “0”.

As described above, since this Action frame is a frame requesting initialization of a BA Bitmap, for example, in the case where “16′h000_0001” is set in the Link Mapping Of TID 0 field and 1 is set in the Direction bit, it indicated that initialization is requested for the BA Bitmap information held by the SCC of the first station STA1-1, which recorded the delivery confirmation of the frame with TID “0” that was transmitted from the first access point AP1-1 to the first station STA1-1 using the wireless link unit with Link ID “0”.

In the Action frame including the BA Bitmap Initialization element shown in FIG. 28(a), the TID and Link ID for requesting initialization need not be limited to only one. It is also possible to request the initialization of the BA Bitmap information indicated by multiple TIDs and Link IDs by setting 1 to multiple bits.

On the other hand, in the format shown in FIG. 28(b), the BA Bitmap Initialization element includes an Element ID field, a Length field, an Element ID Extension field, an Initialization Control field, and a Link Info field.

The Initialization Control field is configured by 2 bits of Direction bits and 6 bits of Reserved bits.

As in the case shown in FIG. 28(a), the Direction bit indicates the direction of frame transmission, where 0 means an uplink direction (i.e., the direction in which the wireless terminal STA MLD transmits frames to the wireless base station AP MLD) and 1 means a downlink direction (i.e., the direction in which the wireless base station AP MLD transmits frames to the wireless terminal STA MLD). Note that 2 indicates bidirectional, which means that frames are transmitted in both the uplink and downlink directions.

The Reserved bit is an unused bit and is basically set to 0.

The Link Info field includes a Link ID sub-field and a TID sub-field. In the Link ID sub-field, a Link ID of the BA Bitmap information to be initialized is set. In the TID sub-field, a TID of the BA Bitmap information to be initialized is set.

For example, in a case where the Direction bit is set to 1, the Link ID is set to 0, and the TID is set to 0, it indicates that initialization is requested for the BA Bitmap information held by the SCC of the first station STA1-1, which recorded the delivery confirmation of the frame with TID “0” that was transmitted from the first access point AP1-1 to the first station STA1-1 using the wireless link unit with Link ID “0”.

The format shown in FIG. 28(b) can request the initialization of the BA Bitmap information indicated by one set of TID and Link ID for one Action frame transmission, which is simpler to set up than the format shown in FIG. 28(a).

An example of another method of initializing the SCC of the first station STA1-1 is, for example, to renegotiate the BA mechanism.

Normally, in the case of starting BA, a device that plans to transmit data (originator) first transmits an ADDBA Request frame to a destination device (recipient) to request starting the BA mechanism. The recipient receiving the ADDBA Request frame returns an ADDBA Response frame to the originator if there is no problem in starting the BA mechanism. This exchange of the ADDBA Request/Response frames completes the negotiation of the BA mechanism, and data (or A-MPDU) transmission is started.

On the other hand, in the case of ending the BA mechanism, the device requesting the termination (originator or recipient) transmits a DELBA frame to the other side. In this manner, the BA mechanism is ended. The originator and recipient may be a wireless base station or a wireless terminal, respectively.

In the following, using this negotiation mechanism, the procedure of initializing the BA Bitmap of the first station STA1-1 will be described by the first access point AP1-1 re-exchanging ADDBA Request/Response frames with the first station STA1-1.

First, the first access point AP1-1 (here, the originator) transmits a DELBA frame to the first station STA1-1 (here, the recipient) to end the BA mechanism for a specific link (also referred to as “DELBA target”). On the other hand, the BA mechanism for links other than the first station STA1-1 (e.g., the second station STA1-2) within the first wireless terminal STA MLD1 continues.

After the transmission of the DELBA frame, the first access point AP1-1 transmits an ADDBA Request frame to the first station STA1-1 and receives an ADDBA Response frame from the first station STA1-1, thereby re-establishing the BA mechanism. An example of the frame format of the DELBA frame and ADDBA Request frame used in this case is described below.

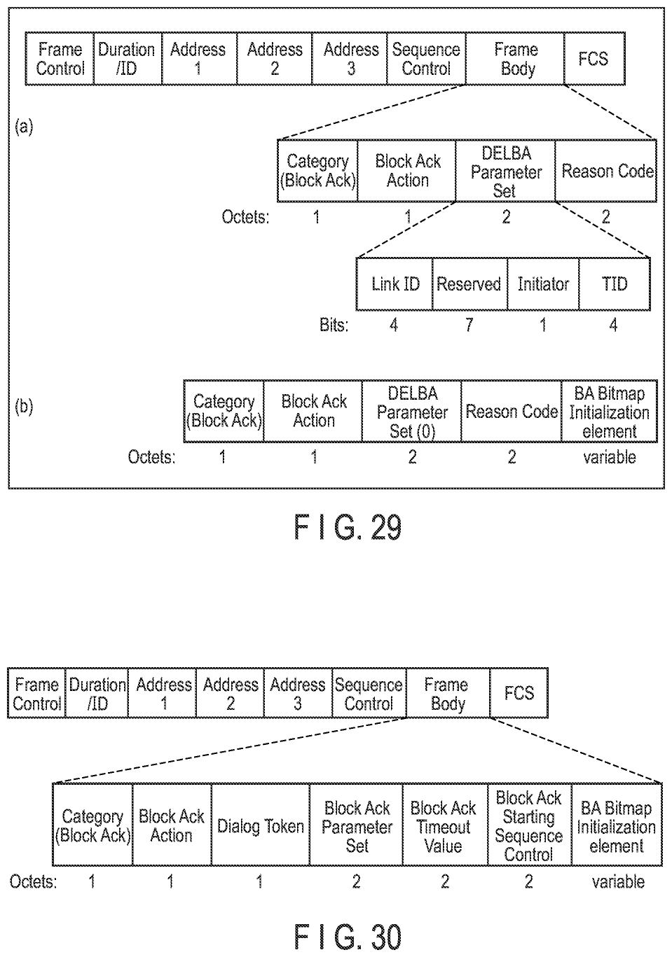

FIG. 29 shows the frame format of the DELBA frame. In the following, two types of DELBA frames will be described.

In the format shown in FIG. 29(a), a Frame Body field includes a Category field, a Block Ack Action field, a DELBA Parameter Set field, and a Reason Code field. The Frame Body field may further include fields other than these.

The Category field is set to a value that indicates that the frame is a Block Ack related frame, and is set to, for example, 3.

In the Block Ack Action field, the action type of the frame used in the Block Ack negotiation is set, which is, for example, 2, indicating that it is a DELBA.

The DELBA Parameter Set field is set with information on which BA negotiation is the DELBA target. The DELBA Parameter Set field includes a Link ID sub-field, an Initiator sub-field, and a TID sub-field. A Reserved sub-field indicates an unused area and is set to 0.

In the Link ID sub-field, the ID of the link to be the DELBA target is set. For example, in a case where the DELBA target of the first access point AP1-1 is the first station STA1-1, Link ID “0” is set. Note that, here, a case in which the DELBA target is the first station STA1-1 is assumed; however, for example, in a case where the second station STA1-2 is the DELBA target, Link ID “1” is set.

The Initiator sub-field is set to indicate whether the device transmitting the DELBA frame is an originator or a recipient. In the case where 1 is set, it means that the DELBA frame is transmitted by the originator, and in the case where 0 is set, it means that the DELBA frame is transmitted by the recipient.

In the TID sub-field, the TID of the data frame to be the DELBA target is set. For example, in a case where the DELBA target (BA mechanism to be ended) is a TID in a state where the first access point AP1-1 has established ADDBA (BA mechanism established) with respect to the first station STA-1 with TID “0”, the TID sub-field is set to 0.

The Reason Code field is set to a value indicating the reason for the DELBA. Here, since the DELBA is to initialize the BA Bitmap, for example, 100, indicating “BA_Bitmap_Initialization”, is set. This value can be any other value as long as it does not conflict with the value already in use and it is 65535 or below.

By the first access point AP1-1 transmitting the DELBA frame with the frame format shown in FIG. 29(a) to the first station STA1-1, and the frame being received by the first station STA1-1, the first station STA1-1 is able to recognize which BA negotiation is to be ended from the Link ID and TID. Furthermore, when the Reason code is “BA_Bitmap_Initialization”, it is possible to recognize that the BA negotiation is not ended completely, and the Scoreboard Context Control information of a specific link is to be initialized. Therefore, it is possible for the RxRBC of the first wireless terminal STA MLD1 to not discard the information in the Receive Reordering Buffer even if it receives this DELBA frame.

Note that, if the Reason Code is a value indicating “END_BA”, the first stat on STA1-1 recognises that the BA negotiation is to be completely ended and either discards the information in the Receive Reordering Buffer or transfers all frames remaining in the Reordering Buffer to an upper layer and ends the RA negotiation.

On the other hand, in the format shown in FIG. 29(b), the Frame Body field further includes a BA Bitmap Initialization element field in addition to the various fields described above.

In the case of the format shown in FIG. 29(b), because of the presence of the BA Bitmap Initialization element field, the DELBA Parameter Set field is considered an unused field and is set to 0. This is because the Link ID and TID are included in the BA Bitmap Initialization element field. For this reason, the DELBA Parameter Set field itself may be omitted. However, considering the complexity of adding information to determine whether the DELBA Parameter Set field exists or not, it is preferable to leave the DELBA Parameter Set field as an unused field and add the BA Bitmap Initialization element field after the Reason Code.

The BA Bitmap Initialization element field is the same as the BA Bitmap Initialization element field included in the Action frame shown in FIG. 28. The BA Bitmap Initialization element field shown in FIG. 28(a) and the BA Bitmap Initialization element field shown in FIG. 28(b) can both be applied.

By the first access point AP1-1 transmitting the DELBA frame with the frame format shown in FIG. 29(b) to the first station STA1-1, and the frame being received by the first station STA1-1, the first station STA1-1 is able to recognize which BA negotiation is to be ended from the Link ID and TID in the BA Bitmap Initialization element field. Also, in the case where the BA Bitmap Initialization element field shown in FIG. 28(a) is applied, it is possible to include multiple pieces of information on the Link ID and TID, thereby allowing the BA negotiation for multiple Link ID and TID pairs to be ended with one DELBA frame.

Furthermore, when the Reason code is “BA_Bitmap_Initialization”, it is possible to recognize that the BA negotiation is not ended completely, and the Scoreboard Context Control information of a specific link is to be initialized. Therefore, it is possible for the RxRBC of the first wireless terminal STA MLD1 not to discard the information in the Receive Reordering Buffer even if it receives this DELBA frame.

FIG. 30 shows the frame format of the ADDBA Request frame. As shown in FIG. 30, a Frame Body field of the ADDBA Request frame includes a Category field, a Block Ack Action field, a Dialog Token field, a Block Ack Parameter Set field, a Block Ack Timeout Value field, a Block Ack Starting Sequence Control field, and a BA Bitmap Initialization element field. The Frame Body field may further include fields other than these.

The Category field is set to a value indicating that the frame is a Block Ack related frame, and is set to, for example, 3.

In the Block Ack Action field, the action type of the frame used in the Block Ack negotiation is set, which is, for example, 0, indicating that it is an ADDBA Request.

The Dialog Token field is used to associate the ADDBA Request frame with the ADDBA Response frame which is the response to the ADDBA Request frame. In this case, the device transmitting the ADDBA Request frame (here, the first access point AP1-1) sets a value other than 0 to this field. On the other hand, the device transmitting the ADDBA Response frame (here, the first station STA1-1) includes the same value as the value of the Dialog Token field included in the ADDBA Request frame in the ADDBA Response frame.

The Block Ack Parameter Set field is set with information about the supported functions in the BA mechanism. Although details are omitted in FIG. 30, the Block Ack Parameter Set field includes an Aggregated MSDU (MAC Service Data Unit) (A-MSDU) Supported sub-field, a Block Ack Policy sub-field, a TID sub-field, and a Buffer Size sub-field.

The A-MSDU Supported sub-field is set with information indicating whether or not A-MSDU is supported. The Block Ack Policy sub-field is set with information indicating that an HT-immediate block ack (returning the BA frame in SIFS after receiving the A-MPDU) mode is supported. The TID sub-field is set with a TID that requests performing ADDBA. In the Buffer Size sub-field, a value of the size of the receive buffer to be used is set. Based on this value, the recipient (here, the first station STA1-1) determines the memory size for storing MPDUs in the Reordering Buffer of the RxRBC and the memory size of the BA Bitmap that holds the SCC's data reception history. In the case where the buffer size indicated in the ADDBA Request frame is larger than the amount of memory supported by the first station STA1-1, the buffer size supported by the first station STA1-1 can be returned in the ADDBA Response frame.

In the Block Ack Timeout Value field, a Timeout time for ending the BA mechanism is set. After the BA mechanism is established, in a case where this time elapses without any frame exchange being performed using the BA mechanism, the BA mechanism is ended.

The Block Ack Starting Sequence Control field includes a Starting Sequence Number sub-field and a Fragment Number sub-field. The Fragment Number sub-field is set to 0. The Starting Sequence Number sub-field is set to a sequence number of a data frame that is to be transmitted after the ADDBA is re-established.

The BA Bitmap Initialization element field is the same as the BA Bitmap Initialization element field to be included in the Action frame shown in FIG. 22. The BA Bitmap Initialization element field shown in FIG. 28(a) and the BA Bitmap Initialization element field shown in FIG. 28(b) may both be applied.

In the case where the length of the Frame Body field in the ADDBA Request frame is greater than 9 bytes, the recipient (here, the first station STA1-1) receiving the frame can recognize that additional fields are included, and, from the values of the Element ID field and the Element ID Extension field, that the additional field is the BA Bitmap Initialization element field.

In the case where the BA Bitmap Initialization element field is included, the TID in the Block Ack Parameter Set field set to 0, indicating that it is an unused field.

By the first access point AP1-1 transmitting the ADDBA Request frame with the frame format shown in FIG. 30 to the first station STA1-1, and the frame being received by the first station STA1-1, the first station STA1-1 is able to recognize, from the Link ID and TID in the BA Bitmap Initialization element field, which BA negotiation is to be re-established with the first access point AP1-1 (recognizable from the Address2 field). Furthermore, in the case where the BA Bitmap Initialization element field is included, it can be determined that the reception history in the SCC of the first station STA1-1 is requested to be initialized, and that it is not necessary to initialize the Reordering Buffer in the RxRBC.

This allows only the reception history held by the SCC of the first station STA1-1 to be initialized while continuing to perform wireless communications for wireless links that do not need to be initialized (e.g., the second station STAT1-2).

As an example of yet another method of initializing the SCC of the first station STA1-1, there is a method in which, for example, the originator (here, the first access point AP1-1) transmits a BAR frame.

In this method, the first access point AP1-1 initializes the BA Bitmap of the first station STA1-1 by setting the sequence number of the data frame to be transmitted in the SSN field of the BAR.

In the case where the first access point AP1-1 transmits a new data frame and does not receive a BA frame from the first station STA1-1, or receives a BA frame that is not intended by the first access point AP1-1 (for example, the first access point AP1-1 confirms the BA Bitmap information in the BA frame, but determines that it is not the BA Bitmap information including the delivery confirmation information of the data frame transmitted by the first access point. AP1-1), the first access point AP1-1 retransmits the data frame. However, in the case where the first access point AP1-1 does not succeed in transmitting the data frame even after retransmitting it M times (where M is an integer greater than or equal to 0), it gives up transmitting the data frame.

Subsequently, the first access point AP1-1 transmits another new data frame. Also for this new data frame, in the case where the first access point AP1-1 does not receive a BA frame from the first station STA1-1, or receives a BA frame that is not intended by the first access point AP1-1, the first access point AP1-1 retransmits this new data frame. However, in the case where the transmission is not successful even after M times of retransmissions, the first access point AP1-1 also gives up transmitting this new data frame. In the case where such an operation is repeated N times (where N is an integer greater than or equal to 0), the first access point AP1-1 transmits a BAR frame in which the sequence number of the data frame to be transmitted to the first station STA1-1 is set in the SSN field.

On the other hand, in the above method using the existing BAR frame, in the case where the BAR frame is received by the first station STA1-1, the rules of operation are limited to the provisions of the current IEEE 802.11 standard. For example, there is a problem that, in the case where the value of SSN in the BAR frame is included in the Range 3 range shown in FIG. 20, the initialization of the BA Bitmap will not be performed in the first station STA1-1.

In the following, a BAR frame that can solve such a problem is described. In this BAR frame, the fields necessary to initialize the BA Bitmap are added.

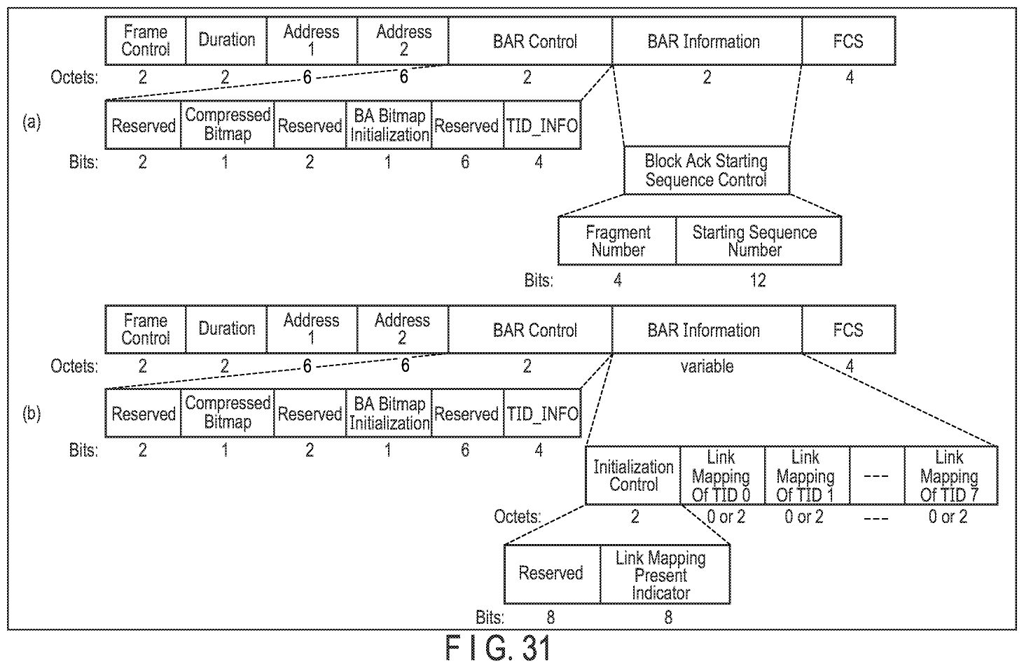

FIG. 31 shows a frame format of the BAR frame. In the following, two types of BAR frames are described. Note that only the major fields are explained in the following.

As shown in FIG. 31(a), a BAR Control field of the BAR frame includes a BA Bitmap Initialization bit.

In an Address 1 field, a MAC address of a recipient (here, the first station STA1-1) that resets the BA Bitmap is set.

By setting the BA Bitmap Initialization bit to 1, the first station STA1-1 can recognize that it is requested to initialize the BA Bitmap. In addition, by setting the BA Bitmap Initialization bit to 1, the first station STA1-1 can initialize the BA Bitmap even if the SSN value in the received BAR frame is in any position of Range 1 to Range 3. Furthermore, by setting the BA Bitmap Initialization bit to 1, information of the Scoreboard Context Control (BA Bitmap) of a specific link (here, the first station STA1-1) can be initialized. According to this, the RxRBC of the first station STA1-1 would not discard or update the information in the Receive Reordering Buffer held by the RxRBC even if this BAR frame is received.

In a TID_INFO field, a TID that requests the initialization of the BA Bitmap is set.

A Starting Sequence Number sub-field is set to the sequence number of a data frame to be transmitted by the first access point AP1-1 to the first station STA1-1. On the other hand, a Fragment Number sub-field is set to 0.

According to the BAR frame shown in FIG. 31(a), the BA Bitmap Initialization bit allows the first station STA1-1 to recognize that the first access point AP1-1 is requesting the initialization of the BA Bitmap, and to specify the wireless link (here, the first station STA1-1) and the TID to which the initialization of the BA Bitmap is requested. Also, according to the BAR frame shown in FIG. 31(a), the BA Bitmap can be initialized at the first station STA1-1 regardless of which position of Range 1 to Range 3 the SSN value in the received BAR frame is in. Furthermore, according to the BAR frame shown in FIG. 31(a), only the BA Bitmap information of a specific wireless link (here, the first station STA1-1) can be initialized. Therefore, the BA Bitmap information of another wireless link that is not specified as the destination of the BAR frame (e.g., the second station STA1-2) would not be initialized, and the RxRBC of the first wireless terminal STA MLD1 would not discard the information in the Receiving Reordering Buffer by receiving the BAR frame. Thus, wireless communication using other wireless links can be continued.

The BAR frame shown in FIG. 31(a) can be easily configured with few changes from the existing BAR frame. In addition, by setting the BA Bitmap Initialization bit to 0, it can function as an existing BAR frame.

On the other hand, in the format shown in FIG. 31(b), the BAR Information field includes an Initialization Control field and a Link Mapping Of TID n (where n indicates one of the values from 0 to 7) field. The initialization Control field includes a Link Mapping Present indicator sub-field, while a Direction sub-field is treated as Reserved. This is because the BAR frame is a frame transmitted by the originator, the direction of frame transmission does not necessarily have to be set in other fields.

The BA Bitmap Initialization bit is the same as in FIG. 31(a). In the case where the BA Bitmap Initialization bit is 1, it can further indicate that the BAR Information field includes the Initialization Control field and the Link Mapping Of TID 0 to Link Mapping Of TID 7. On the other hand, in the case where the BA Bitmap Initialization bit is 0, it can indicate that a Block Ack Starting Sequence Control field is included, and the BAR frame can function as an existing BAR frame.

The Link Mapping Present Indicator sub-field functions in the same way as the Link Mapping Present Indicator in the BA Bitmap Initialization element included in the Action frame shown in FIG. 28(a).

The Link Mapping Of TID 0 to Link Mapping Of TID 7 fields function in the same way as the Link Mapping Of TID 0 to Link Mapping Of TID 7 of the BA Bitmap Initialization element shown in FIG. 28(a).

According to the BAR frame shown in FIG. 31(b), it is possible to request the initialization of multiple pieces of BA Bitmap information. In addition, since the RxRBC of the first wireless terminal STA MLD1 does not discard the information in the Receiving Reordering Buffer upon reception of the BAR frame, it is possible to continue wireless communication using other wireless links where initialization is not requested.

According to at least one embodiment described above, it is possible to provide a wireless communication device 300 (wireless base station AP MLD and wireless terminal STA MLD) and a wireless communication system capable of realizing efficient communication using multi-link transmission technology.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication device comprising:
a control unit configured to generate a first frame based on data and management information corresponding to the data; and
a wireless unit configured to transmit the first frame to a first communication device, wherein
the control unit is configured to:
confirm whether or not a notification including the management information that the first frame was successfully transmitted is received from a second communication device which is different from the first communication device,
transmit, in a case where the notification is not received, the first frame to the first communication device via the wireless unit, and transmit, in a case where a response frame with respect to the first frame is successfully received from the first communication device, the notification including the management information to the second communication device, and
discard, in a case where the notification is received, the first frame.

2. The wireless communication device of claim 1, wherein
the first frame includes a first number corresponding to the data and a first ID indicating a type of the data, and
the management information is determined according to the first number, the first ID, and destination information of the first frame.

3. The wireless communication device of claim 1, wherein the control unit is configured to:
confirm, in a case where a response frame from the first communication device is not successfully received, whether or not the number of transmission of the first frame has reached a retransmission count limit,
transmit, in a case where the retransmission count limit has not been reached, the first frame to the first communication device via the wireless unit, and
discard, in a case where the retransmission count limit has been reached, the first frame.

4. The wireless communication device of claim 2, wherein the control unit is configured to:
receive, from a third device that is different from the first and second communication devices, a second frame including the data, the first ID, the first number, and the management information, and
include the first ID and the first number in the first frame.

5. A wireless communication device comprising:
a control unit configured to generate a first frame based on data and a first number corresponding to the data; and
a wireless unit configured to transmit the first frame, wherein
the control unit is configured to:
hold first information that is determined based on at least a range that the first number may take, and
generate, in a case where a difference between the first number corresponding to the first frame to be transmitted and a second number corresponding to a second frame that has already been successfully transmitted exceeds a value indicated by the first information, a third frame including the first number corresponding to the first frame, and transmits the third frame via the wireless unit before transmitting the first frame to be transmitted.

6. The wireless communication device of claim 5, wherein the control unit is configured to generate, in a case where there is a plurality of first frames to be transmitted, a third frame including the smallest first number among the first numbers corresponding to each of the plurality of first frames, and transmits the third frame via the wireless unit.

7. A wireless communication device comprising:
a plurality of wireless units configured to receive one or more first frames using a plurality of different frequency channels;
a plurality of processing units configured to determine that the first frame has been successfully received; and
a control unit, wherein
a first number is assigned to each of the first frames to distinguish the first frames from each other,
each of the processing units is configured to hold reception history information indicating a reception status of the first frame,
the control unit comprises a buffer that temporarily stores part or all of the first frame transferred from each of the processing units, and
the reception history information is updated based on a state of the buffer.

8. The wireless communication device of claim 7, wherein the reception history information is updated based on a comparison of whether or not the first number is a target to be held in the reception history information, and the state of the buffer when the processing unit receives the first frame.

9. The wireless communication device of claim 7, wherein the reception history information is updated according to a result of comparison between holding range information of the reception history information and the state of the buffer.

10. The wireless communication device of claim 8, wherein the buffer stores information indicating a storage range of the first frame.

11. The wireless communication device of claim 7, wherein
the plurality of wireless units include a first wireless unit and a second wireless unit,
the first wireless unit is configured to receive the first frame using a first frequency channel, and
the second wireless unit is configured to receive the first frame using a second frequency channel that is different from the first frequency channel.

12. The wireless communication device of claim 11, wherein the first wireless unit and the second wireless unit are each capable of independently receiving the first frame with a different first number.
